(19) United States
(12) Patent Application Publication
(10) Pub. No.: US 2009/0240582 A1
(43) Pub. Date: Sep. 24, 2009

(54) Systems and methods for providing purchasing incentives and advertisements

(76) Inventors: Andrew Michael Sheldon-Neal, Bournemouth (GB); Andrew Ronald Vining, Ringwood (GB)

Correspondence Address: MAIER & MAIER, PLLC, 1000 DUKE STREET, ALEXANDRIA, VA, 22314, US

(21) Appl. No.: 12/153,324

(22) Filed: May 16, 2008

Related U.S. Application Data
(60) Provisional application No. 61/064,648, filed on Mar. 18, 2008.

(51) Int. Cl. G06Q 10/00; G06Q 30/00

(52) U.S. Cl. 705/14

(57) ABSTRACT

In accordance with at least one exemplary embodiment, system and methods for providing purchasing incentives and/or advertisements are disclosed. An exemplary system can include an application suite stored and executable on one or more servers. The application suite can have one or more modules, including any of an advertisers module, a consumers module, a channel partners module, an affiliates module and a system provider module. The advertisers (and affiliates) module can include design functionality, demographical-targeting functionality, promotional campaign planning functionality and promotional campaign management functionality. The consumers module can provide purchasing incentives (e.g., coupons) or other advertisements in at least one of a demographically-targeted manner, a searchable manner and a hierarchally-arranged manner. The consumers module can also include registration functionality wherein consumer data is solicited and can be shared with any of advertisers, affiliates and channel partners. The system provider (and channel providers) module can include administrative functionality.

### CROSS REFERENCE TO RELATED APPLICATIONS

This application claims priority, under 35 U.S.C. §119(e), to U.S. Provisional Patent Application Ser. No. 61/064,648, filed Mar. 18, 2008, the disclosure of which is incorporated by reference herein in its entirety.

### BACKGROUND

Numerous goods and services providers issue coupons for their products. Coupons are often both a form of advertising and a type of purchasing incentive. Other purchasing incentives include rebates and advertisements of products at discounted prices. Generally, advertisements are any notice for calling public attention to the products of providers whether or not they offer a discount or gift. Coupons are issued to entice consumers to purchase goods and services from particular providers whether a provider is a manufacturer, retailer or other type of business. Coupons are typically issued in limited numbers, although the quantity of coupons issued may be quite large, and for a limited duration (e.g., defined by an expiration date). Coupons provide a discount or gift to those consumers that redeem them according to the terms of the coupons. For example, coupons will often reduce the purchase price of one or more products by a fixed or percentage amount, increase the quantity of products sold at a purchasing price, or provide related products at a reduced purchasing price or for no additional charge. Indeed, coupons provide consumers with “more for less.”

Product providers issue coupons for numerous promotional reasons. Coupons are also distributed to consumers in a variety of ways. Coupons are issued to entice consumers to try new products, shore up sales, reduce inventory, develop or regain consumer loyalty, and increase or maintain market share, among other reasons. Coupons are delivered via numerous publications, direct mailings, free standing inserts, in-store dispensers, printed store receipts, on-product means and peel-off means, to name a few. Coupons are also now delivered electronically via the Internet.

Product providers are interested in designing coupons for and delivering coupons to consumers they desire to obtain as customers while increasing efficiency and reducing the costs associated with coupon design and distribution. In addition, product providers would benefit from obtaining relevant consumer information from interested consumers in order to advance the product providers' marketing strategies and further target their potential customer base.

Global, national, regional and local product providers issue coupons for their goods and services. All sizes of product producers issue electronic coupons via the Internet. Nevertheless, small (particularly, local) product providers appear to be underrepresented as issuers of electronic coupons in comparison to overall coupon issuance. This is likely due to less advertising resources and less technical/computer know-how.

### SUMMARY

According to at least one exemplary embodiment, a system for providing purchasing incentives or advertisements is disclosed. The system can include one or more servers on a network and one or more data storage devices on the network where the one or more data storage devices are operatively connected to the one or more servers. An application suite can be stored and executable on the one or more servers. The application suite can have more than one module. The more than one module can include a first module for advertisers and a second module for consumers. The first module can include any of purchasing incentive/advertisement design functionality, demographical-targeting functionality, promotional campaign planning functionality and promotional campaign management functionality. The second module can provide any of a plurality of purchasing incentives and a plurality of advertisements via the network in at least one of a demographically-targeted manner, a searchable manner and a hierarchally-arranged manner. The second module can also include registration functionality wherein contact data, demographic data and/or categorical data is solicited from consumers during a registration process.

In another exemplary embodiment, a method of providing coupons to consumers is disclosed. The method can include providing a plurality of preformatted coupon templates and a plurality of template data entry mechanisms on an advertisers module of a website. The method can also include accepting a template selection and coupon data where the coupon data is entered via the plurality of template data entry mechanisms. The method can further include populating a preformatted coupon template according to the template selection and the coupon data entered. Yet further, the method can include receiving a request to issue coupons on the advertisers module of the website and publishing a plurality of printable coupons on a consumers module of the website.

In yet another exemplary embodiment, a method of sharing consumer data with advertisers is disclosed. The method can include publishing a plurality of coupons, provided by advertisers, on a consumers module of a website. The method can also include limiting the printing of the plurality of coupons to registered consumers, collecting consumer data from consumers during registration, receiving requests to print the plurality of coupons, accepting the requests to print the plurality of coupons, providing the plurality of coupons in printable form, and sharing the consumer data on an advertisers module of the website.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 diagrammatically illustrates an exemplary network connecting advertisers, affiliates, consumers and channel partners with a system provider;

FIG. 2 is a website map illustrating a portion of an exemplary website of the system provider;

FIG. 3 is a website map illustrating an exemplary advertisers module of the exemplary website;

FIG. 4 shows an exemplary GUI portion of the exemplary advertisers module;

FIG. 5 shows another exemplary GUI portion of the exemplary advertisers module;

FIG. 6 shows yet another exemplary GUI portion of the exemplary advertisers module;

FIG. 7 shows still another exemplary GUI portion of the exemplary advertisers module;

FIG. 8 shows a further exemplary GUI portion of the exemplary advertisers module;

FIG. 9 shows yet a further exemplary GUI portion of the exemplary advertisers module;

FIG. 10 is a website map illustrating an exemplary consumers module of the exemplary website;

FIGS. 11A & 11B show an exemplary GUI portion of the exemplary consumers module;

FIG. 12 is a website map illustrating an exemplary channel partners module of the exemplary website;

FIG. 13 is a website map illustrating an exemplary affiliates module of the exemplary website;

FIG. 14 is a website map illustrating an exemplary system provider module of the exemplary website;

FIG. 15 shows an exemplary electronic coupon in graphical or printed form; and

FIG. 16 is a flowchart illustrating an exemplary process for pooling and providing any of purchasing incentives and advertisements from a global pool on the exemplary system.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the terms “embodiments of the invention,” “embodiments” or “invention” do not require that all embodiments of the invention include the discussed feature, advantage or mode of operation.

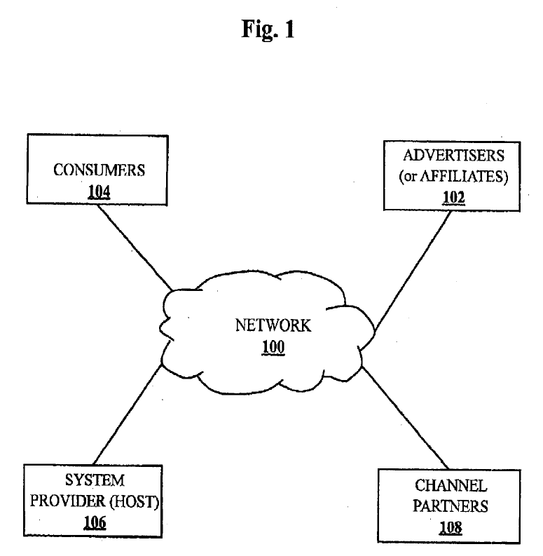

Referring to FIG. 1, network 100 can connect advertisers 102 (and any affiliates acting on behalf thereof), consumers 104, system provider 106 and any channel partners 108. Network 100, or at least a portion thereof, can be the Internet. Alternatively, singularly or in conjunction, network 100 (or portions thereof) can be any other network known to one having ordinary skill in the art.

System provider 106 can provide at least one system on network 100 for providing any of purchasing incentives and advertisements from advertisers 102 to consumers 104. In at least one exemplary embodiment, a system for providing any of purchasing incentives and advertisements can provide coupons issued by advertisers 102 (or affiliates on behalf thereof) to consumers 104 for redemption. The at least one system can provide at least one application suite (or any modules, programs and executable code thereof) on network 100. The application suite can be predominantly or wholly web-based. Features of the application suite can be accessed via network 100 by advertisers 102, any affiliates, consumers 104 and any channel providers 108 operating client computing devices running web-browsers and connected to network 100. As will be readily recognized by one having ordinary skill in the art, system provider 106 can have access to the features and underlying code of the application suite locally and/or remotely.

The system can include one or more servers on network 100. The one or more servers can be operatively connected to one or more storage devices (digital repositories), which may be any one or more suitable databases known to one having ordinary skill in the art. The application suite (or the majority of features and functionalities thereof) can be executable on the one or more servers. The application suite can be functionally grouped into one or more modules where the modules provide a variety of features and functionalities to advertisers 102, any affiliates, consumers 104 and any channel providers 108. These modules can include any of an advertisers module, an affiliates module, a consumers module, a channel providers module and a system provider module. Each module can have a variety of features and functionalities, which features and functionalities may overlap and/or be substantially similar to features and functionalities of other modules. Also, while most features and functionalities are contemplated to be, but are not so limited, accessed remotely by advertisers 102, any affiliates, consumers 104 and any channel providers, some features and functionalities may be accessed locally by the same.

Advertisers 102 are a type of user of the system for providing any of purchasing incentives and advertisements. The purchasing incentives/advertisements can be published by the system of system provider 106. Advertisers 102 can be any of local, regional, national or global businesses that provide goods and/or services (i.e. products). Additionally, advertisers 102 can be any other person or organization that advertises. Advertisers 102 can operate client computing devices connected to network 100 for accessing features and functionalities of the system. Advertisers 102 can access the system in order to provide any of purchasing incentives and advertisements to consumers 104. In at least one exemplary embodiment, advertisers 102 can do so in order to design and/or issue coupons that can be printed and redeemed by authorized consumers 104.

Affiliates acting on behalf of advertisers 102 are another type of user of the system for providing any of purchasing incentives and advertisements. Affiliates can be representatives or agents of advertisers 102. For example, affiliates can be consultants, consulting firms, advertising agencies and the like. Affiliates can operate client computing devices connected to network 100 for accessing features and functionalities of the system. Affiliates can access the system in order to provide any of purchasing incentives and advertisements to consumers 104 on behalf of advertisers 102. In at least one exemplary embodiment, affiliates can do so in order to design and/or issue coupons that can be printed and redeemed by authorized consumers 104.

Consumers 104 are another type of user of the system for providing any of purchasing incentives and advertisements. Consumers 104 can be members of the general public and can be potential customers of advertisers 102. Consumers 104 can operate client computing devices connected to network 100 for accessing features and functionalities of the system. Consumers 104 may be directed to the system via websites of channel providers 108 or may directly access the website of service provider 106. Consumers 104 can be provided a plurality of purchasing incentives or a plurality of advertisements in at least one of a searchable manner, a hierarchally-arranged manner and a targeted (whether by demographic and/or categorical data) manner. Consumers 104 may thus view purchasing incentives or advertisements provided by advertisers 102 on the system. In at least one exemplary embodiment, consumers 104 can view coupons provided on the system by advertisers 102. Furthermore, consumers 104 can be authorized and given access to print such coupons for redemption.

Also, in at least one exemplary embodiment, registered consumers 104 can be directed to any of purchasing incentives and advertisements by demographic and/or categorical data supplied by such consumers 104 during registration and associated with any of purchasing incentives and advertisements by advertisers 102 in carrying out a promotional (marketing) campaign. Consumers 104 can be directed to any of purchasing incentives and advertisements matching the supplied demographic and/or categorical data (e.g., at a consumers home webpage), but may be able to search or otherwise find purchasing incentives or advertisements associated with other demographic and/or categorical data. Alternatively, consumers 104 can be limited to purchasing incentives or advertisements matching the supplied demographic and/or categorical data. Moreover, unregistered consumers 104 may have to register and supply demographic and/or categorical data in order to access any of purchasing incentives and advertisements published on the system matching such demographic and/or categorical data. Furthermore, registered consumers 104 can have the ability to refer (share) any of purchasing incentives and advertisements with other registered and unregistered consumers 104, for example, by email. Unregistered consumers 104 may also have to register before viewing and/or printing any of purchasing incentives and advertisements. In at least one exemplary embodiment, consumers 104 may have to be registered and logged-in in order to print coupons.

Channel partners 108 are another type of user of at least one system for providing any of purchasing incentives and advertisements. Channel partners 108 can serve to direct consumers 104 to purchasing incentives or advertisements provided by advertisers 102 on the system. In at least one exemplary embodiment, channel partners 108 can host websites for their businesses/organizations. Channel partners 108 can serve as conduits by directing (e.g., by providing hypertext links on their websites) consumers 104 (and advertisers 102 and any affiliates thereof) to features of the system. System providers 106 can provide a tailored system for each channel partner 108 on behalf thereof, which may be styled to substantially integrate with the website of each channel partner 108. Channel partners 108 themselves may also provide features and functionalities of the systems. Each channel partner 108 can also operate client computing devices connected to network 100 for accessing features of the system, which system may be provided by system provider 106 on behalf of channel partners 108.

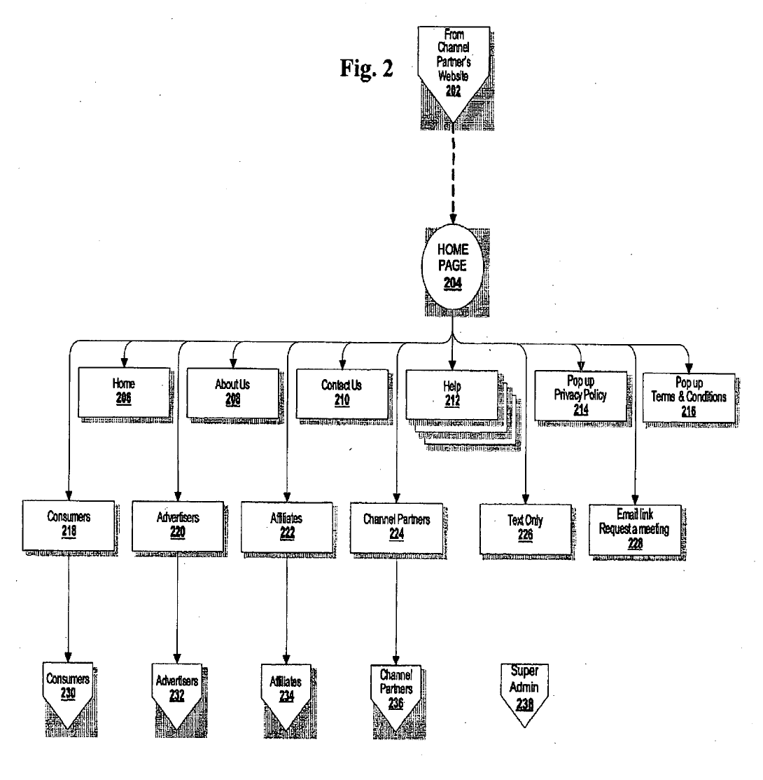

Referring to FIG. 2, a portion of an exemplary website of system provider 106 is illustrated. The exemplary website (or portions thereof) can be hosted by system provider 106 on their own behalf, or, alternatively on behalf of channel partner 108. If the website is hosted by system provider 106 on behalf of channel partner 108, then the website may appear to integrate with website 202 of channel partner 108 giving the appearance to advertisers 102 and consumers 104 that they are navigating within a single website. The exemplary website (or portions thereof) can thus be the system-provider-powered portion of website 202. The exemplary website can have any functionality known to one having ordinary skill in the art. For example, the website can include search functionality. Moreover, drop-down menus and like graphical user interface (“GUI”) widgets can be used to enable a user to filter information and navigate to webpages, as non-limiting examples.

Whether directed by hypertext link from channel partner website 202 or not, users can access home webpage 204 of the exemplary website of system provider 106. Webpage 204 can include top level navigation hypertext links for directing users to associated webpages. The top level navigation hypertext links can appear on all or nearly all webpages of the website. The top level navigation hypertext links and associated webpages can include home link 206, about link 208, contact us link 210, help link 212, privacy policy link 214, and terms and conditions link 216, among other types of navigation links and associated webpages known to one having ordinary skill in the art. In at least one exemplary embodiment, top level navigation hypertext links can allow a user to reach any module or main section of the website within three hypertext link selections (e.g., “clicks”). Other hypertext links can include text only link 226, email link 228 and the like known to one having ordinary skill in the art.

Other webpages, which hypertext links thereto can be placed on various webpages of the website, can include at least one of webpage 218 for consumers 104, at least one webpage 220 for advertisers 102, at least one webpage 222 for affliates and at least one webpage 224 for channel partners 108. Webpages 218, 220, 222, 224 can function as specific (secondary) home pages for consumers 104, advertisers 102, affiliates and channel partners 108, respectively.

In at least one exemplary embodiment, webpages 218, 220, 222, 224 can each respectively serve as a gateway for linking to consumers module 230, advertisers module 232, affiliates module 234 and channel partners module 236 of the website and application suite. System provider module 238 may reside in a non-public portion of the website where super administrators can have unfettered access and other administrators can be authorized for more limited access to features and functionalities.

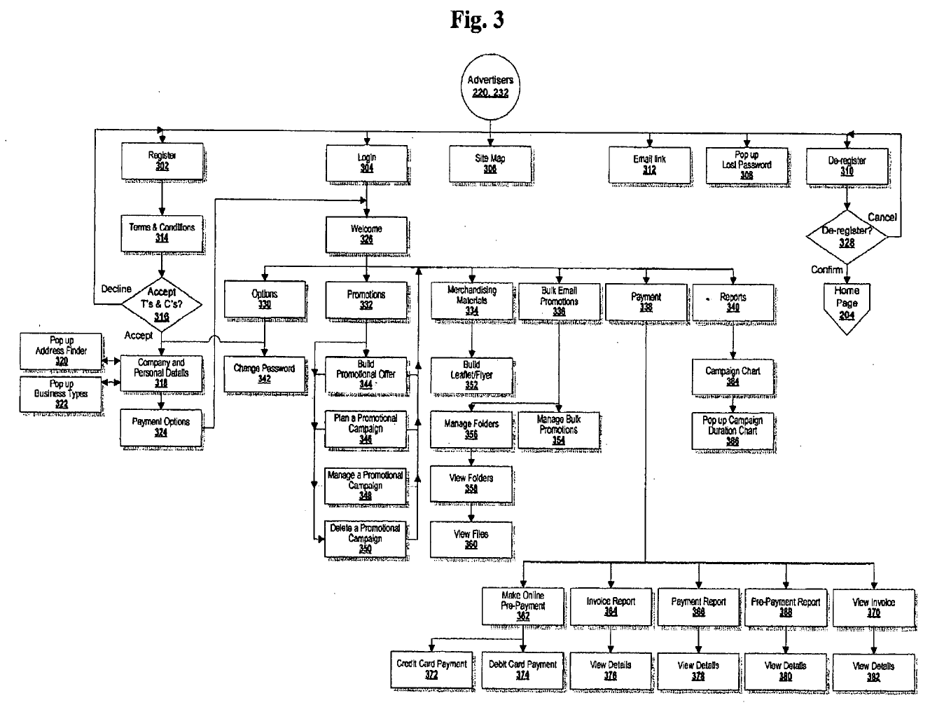

Referring to FIG. 3, an exemplary advertisers module 232 is illustrated as a portion of the exemplary website. At advertisers home webpage 220 of advertisers module 232, hypertext links can be presented to advertisers 102 for registration subportion 302, logged-in advertisers subportion 304 and de-registration subportion 310. At advertisers home webpage 220, any hypertext link known to one having ordinary skill in the art can also be included, such as site map link 306, lost password link 308 and email link 312 for directing advertisers 102 to associated webpages and features.

At registration subportion 302, advertisers 102 can be presented with terms and conditions webpage 314 and can accept the terms and conditions at decision 316. Upon accepting the terms and conditions, advertisers 102 can be presented advertisers account information (e.g., business, user and financial information) webpage 318. At webpage 318 (or, alternatively, at webpage 314), each unregistered advertiser 102 can enter an email address and can enter an account password selected by advertiser 102. At webpage 318, advertisers 102 can enter a variety of account data, including company (or other organization) information, company (or other organization) member information for individual users and financial information. Webpage 318 can be presented to advertisers 102 in form format with various GUI widgets for entering data. Data entered by advertisers 102 can be validated by the system. Data can also be limited to predetermined lengths and types of alphanumeric characters, and can be requested in particular formats. Data can also be limited to predetermined options. Webpage 318 can be later accessed by registered advertisers 102 for updating and editing information where webpage 318 can be pre-populated with stored account data.

Webpage 318 can also be linked to additional webpages for assisting advertisers 102 in entering information or to provide separate webpages for entering types of information. For example, address finder webpage 320 can be linked to for providing advertisers 102 with address identification functionality. Business types webpage 322 can be presented to advertisers 102 for selecting one or more categories of business types which most closely described the businesses of advertisers 102. In addition, payment webpage 324 can be presented to advertisers 102 for providing information related to effectuating payment and/or for selecting how advertisers 102 will be charged by system provider 106. Payment webpage 324 may grant advertisers 102 choices in how they are to be charged by system provider 106, which may include the option to be charged based on coupons printed, where appropriate. Know revenue generating methods may also be included as options.

In at least one exemplary embodiment, advertisers 102 can choose to or may be required to be charged a fee by system provider 106 based on coupons printed by consumer 102. Such a fee may be fixed or subject to auction-style bidding, such as a running auction. For illustrative purposes and in a non-limiting manner, system provider 106 may charge advertisers 102 a fixed fee of a predetermined dollar amount (e.g., one dollar) per each coupon printed by consumer 102. Coupons printed can also be charged at a bulk rate. Alternatively, advertisers 102 may be charged based on coupons viewed, presumably at a lesser rate than coupons printed. Also, in at least one exemplary embodiment, system provider 106 can share revenue generated from advertisers 102 with any channel partners 108 that directed consumers 104 to coupons provided by advertisers 104. Revenue sharing between system provider 106 and channel partners 108 can be based on a fixed or percentage amount (e.g., 50 percent) per coupons printed (or viewed), as a non-limiting example.

In other embodiments, any method of charging and collecting revenue for publishing any of purchasing incentives and advertisements known to one having ordinary skill in the art can be used by system provider 106 and can be presented to advertisers 102 as optional or required. For example, advertisers 102 can be charged based on click-throughs and can be subjected to running auctions on search keywords.

During or upon successful completion of the registration process, advertisers 102 can be assigned unique identifiers (e.g., customer numbers) and channel identifiers. Channel identifiers can be unique to each channel partner 108. Upon registration, advertisers 102 can be directed to and presented with welcome webpage 326 of logged-in subportion 304.

If any registered advertisers 102 decide that they no longer desire to be registered users of the exemplary system, advertisers 102 can link to de-registration subportion 310. At de-registration subportion 310, advertisers 102 can be presented with de-register decision 328. If advertisers 102 select to de-register, then advertisers 102 can be directed to home webpage 204. The exemplary system can de-register such advertisers 102 by, for example, suspending or deleting their accounts.

Still referring to FIG. 3, logged-in advertisers subportion 304 can be for registered and logged-in advertisers 102. Advertisers 102 can login from one or more webpages, including advertisers home webpage 220 of advertisers module 232. Advertisers 102 can login by entering an account name or number (e.g., email address, customer number or other unique identifier) and a password that can be validated by the system. Advertisers 102 can also have login data saved and can be automatically logged-in by, for example, enabled identification cookies programmed to do so, as is well known in the art. Once logged-in, registered advertisers 102 can be presented with welcome webpage 326. Welcome webpage 326 can include hypertext links for directing advertisers 102 to options subportion 330, promotional (marketing) campaign subportion 332, other promotional/merchandising materials subportion 334, bulk email subportion 336, payment subportion 338 and reports subportion 340.

At option subportion 330, advertisers 102 can be presented with advertisers account information webpage 318 where advertisers 102 can edit and update account information and link to webpage 324 for selecting different billing and payment methods. As described above, webpage 318 can be pre-populated with stored account data regarding advertiser 102, which may then be edited. At password webpage 342, advertisers 102 can change the current password to their account where the original password may have been selected and/or assigned during the registration process.

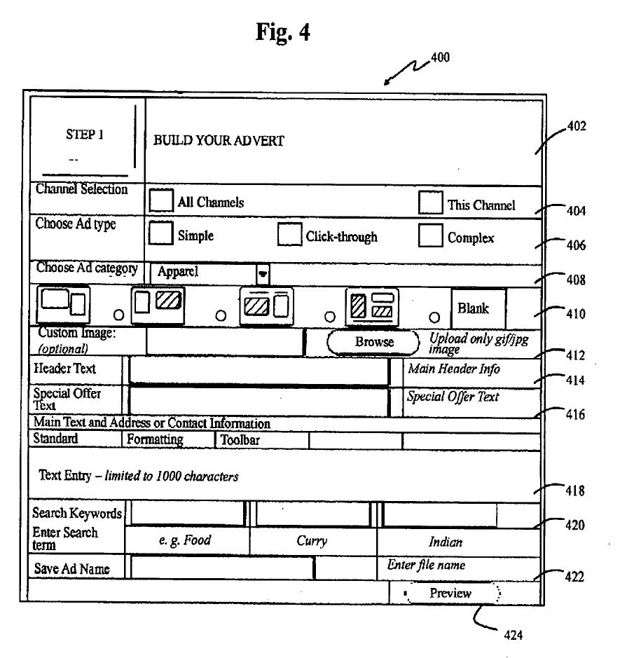

At promotional (marketing) campaign subportion 332, advertisers 102 can build (design) any of purchasing incentives and advertisements. Advertisers 102 can also plan and manage a promotional campaign. By planning and managing a promotional campaign, advertisers 102 can determine the criteria in which any of purchasing incentives and advertisements are distributed and, thus, provided to consumers 104. At promotional campaign subportion 332, at least one webpage 344 can have aspects directed to building/designing any of purchasing incentives and advertisements. At least one webpage 346 can have aspects directed to planning promotional campaigns. At least one webpage 348 can have aspects directed to managing promotional campaigns, which may include features for terminating promotional campaigns, or, alternatively, at least one webpage 350 can have aspects directed to terminating promotional campaigns. As described further below, FIGS. 4-7 show exemplary GUI portions that may be presented to advertisers 102 by webpages 344, 346, 348, 350 of promotional campaign subportion 332.

Still referring to FIG. 3, at other promotional/merchandizing materials subportion 334, one or more webpages 352 can provide advertisers 102 with the ability to design any of leaflets, flyers, business cards and like point-of-sale materials. One or more webpages 352 can include templates for designing such point-of-sale materials. While promotional campaign subportion 332 can be directed, at least in part, to designing any of purchasing incentives and advertisments provided to consumers 104 via the exemplary website, other materials subportion 334 can be directed to providing electronic documents that advertisers 102 can electronically or manually provide to potential customers off-website and without the charges associated therewith.

In at least one exemplary embodiment, at other promotional/merchandizing materials subportion 334, advertisers 102 can be presented a template that allows advertisers 102 to customize and print a business card. Printed business cards can be used at the point-of-sale. In simple form, an exemplary template can have three data entry portions for respectively entering company name, any logo and contact information. Advertisers 102 can be provided options for selecting the size of such printed business cards, which may match with known label sizes provided by popular paper products companies (e.g., AVERY DENNISON).

At bulk email subportion 336, advertisers 102 can be presented at least one webpage 354 directed to managing bulk email promotions. Webpages 356, 358, 360 can also be included to provide advertisers 102 with the ability to manage folders, view folders and view files, respectively. Bulk email subportion 336 can provide advertisers with the ability to send a plurality of emails to a plurality of consumers 104 while providing each consumer 104 with the ability to opt out of such bulk mailings. Bulk email functionality can provide advertisers 102 with the means to send consumers 104 new purchasing incentives, advertisements, general information and the like by email.

In at least one exemplary embodiment, the system can provide a particular advertiser 102 the ability to email registered consumers 104 who have printed one or more coupons of such advertiser 102. The system can provide access to such consumers 104 based on contact data (including at least email addresses) entered by consumers 104 during a consumer registration process. Demographic and/or categorical data can also be collected from consumers 104 during the consumer registration process, which can be used in targeting bulk emails based on such demographic and/or categorical data. By collecting contact and demographic (and/or categorical) data, advertisers 102 can have the ability to follow-up with consumers 104 who have showed interest in the products of advertisers 102. At bulk email subportion 336, advertisers 102 can also have the ability to access (or unlock) consumer contact data (including at least email addresses) and, optionally, demographic and/or categorical data of consumers 104 already known to advertisers 102.

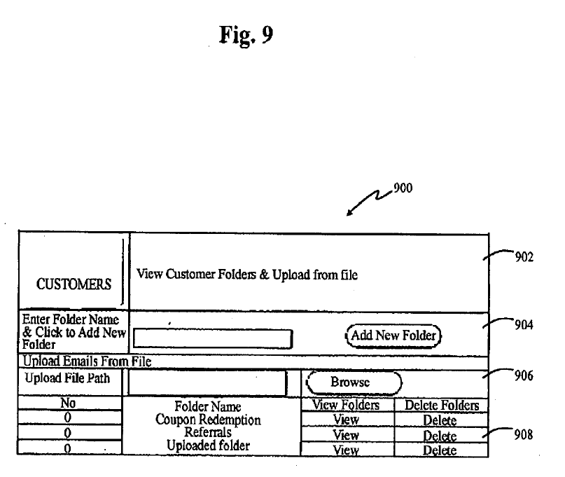

Also, in at least one exemplary embodiment, advertisers 102 can access contact and demographic data of such consumers 104. Folders can be created by advertisers 102 for storing consumer data. Files uploaded and located in the folders can be in Excel, Comma Separated Values (“CSV”) and Access formats, as non-limiting examples. As described further below, FIG. 9 shows an exemplary GUI portion, which may be presented by webpage 356 (or view folder webpage 358). View folder webpage 358 can present all folders accessible to advertiser 102. Folders can also be assigned for each consumer 104 and, within such folders, others subordinate folders can be provided. For example, a coupon redemption folder under a consumer folder can contain files having data regarding number and/or types of coupons printed. A referral folder under a consumer folder can contain files having data regarding coupons shared by each consumer 104 with other registered or unregistered consumers 104, for example, by email.

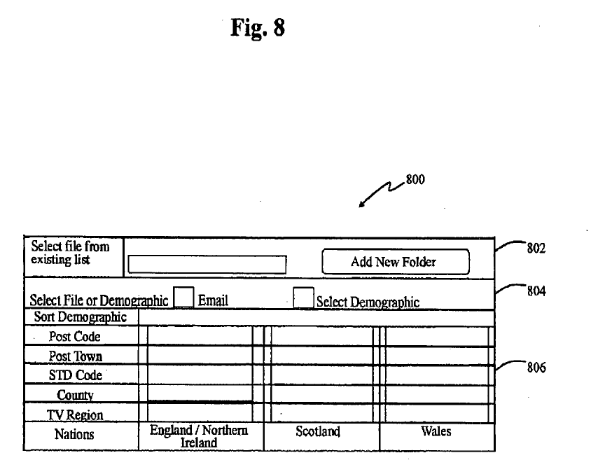

Moreover, in at least one exemplary embodiment, bulk email subportion 226 can provide functionality enabling advertisers 102 to select demographic criteria that advertisers 102 desire to target by a bulk email campaign. For example, demographic data targeted by bulk email can include any of postal codes, cities/towns, telephone STD/area codes, counties, television regions, states/nations and the like. For the convenience of consumers 104, every email generated by bulk email subportion 226 can contain an opt out (unsubscribe) link. Accordingly, consumers 104 can opt out of promotional email campaigns of a particular advertiser 102. In at least one exemplary embodiment, consumers 104 may be automatically opted back in upon printing another coupon of such advertiser 102. As further described below, FIG. 8 shows an exemplary GUI portion (of, for example, webpage 354) for demographically-targeting consumers 104.

At payment subportion 338, advertisers 102 can be presented with various webpages directed to payment-related matters. Payment subportion 338 can include at least one webpage 362 directed to online payment, including pre-payment, for advertisers 102. Online payment webpage 362 can direct advertisers 102 to various webpages catering to one or more payment methods, including, for example, webpages 372, 374 directed to credit card and debit card payments, respectively. In other embodiments, credit card and debit card payments can be effectuated from the same one or more webpages. Payment subportion 338, can include webpages directed to various reports for advertisers 102. Report webpages can include webpages 364, 366, 368, 370 directed to invoice reports, payment reports, pre-payment reports, viewable (e.g., resembling paper) invoice reports, respectively, and the like known to one having ordinary skill in the art. Each report webpage 364, 366, 368, 370 can further include links to one or more webpages 376, 378, 380, 382 for viewing further details of the respective reports.

At reports subportion 340, advertisers 102 can be presented with at least one campaign chart webpage 384. In at least one exemplary embodiment, at campaign chart webpage 384, advertisers 102 can view all consumers 104 that have printed and/or referred (shared) coupons. For example, webpage 324 can include a table showing consumer data, such as names, email addresses, number of coupons printed, number of coupons referred, unique coupon identifiers associated with each coupon and the like. Webpage 384 can link to webpage 386. Webpage 386 can include a campaign duration chart. The campaign chart can present the dates that a promotional campaign(s) is scheduled to run for.

Referring generally to FIGS. 4-7, exemplary GUI portions for webpages of promotional campaign subportion 332 are illustrated. In at least one exemplary embodiment, all or nearly all GUIs of advertisers module 232, particularly promotional campaign subportion 332, can be designed to be user-friendly in a simplified and intuitive manner. While it is contemplated that advertisers 102 can be any of global, national, regional and local product (i.e., goods and services) providers (as well as any other person, entity or organization), it is likewise contemplated that a user-friendly system can particularly attract small market (local extending to some regional) product providers who are believed to be presently underrepresented in the online advertising market. Many small market product providers rely on coupons to target their potential customer base and provide such coupons through various conventional methods. Without being bound by belief, it is also believed that small market product providers, as a segment, have a lesser online advertising presence due to the cost and technical complexity of establishing such a presence. Accordingly, in at least one exemplary embodiment, the exemplary website can provide small market product providers the ability to increase their online presence by providing a user-friendly interface for designing and issuing coupons—a form of advertising many small product providers are familiar with and rely on—in a cost-effective manner. Central to a user-friendly interface can be a what-you-see-what-you-get approach having data entry GUI widgets arranged in a simplified and intuitive manner.

Referring to FIG. 4, exemplary GUI portion 400 is illustrated. GUI portion 400 can be presented by at least one webpage 344, as one non-limiting example. GUI portion 400 can include step and title section 402, channel selection section 404, advertisement type section 406, advertisement product category section 408, template library section 410, image upload section 412, header text entry section 414, secondary (e.g., special offer) text entry section 416, main text entry section 418, keyword section 420, advertisement file name section 422 and preview link 424. Sections can be modified, rearranged, omitted and new sections added, as will be readily recognized by one having ordinary skill in the art.

In step and title section 402, GUI portion 400 can display information identifying the purpose (e.g., “build your advert”) of portion 400 and the predetermined step (e.g., “step 1”) that portion 400 can be in an exemplary process. In channel selection section 404, advertisers 102 can select whether a purchasing incentive or advertisement under design is to be provided on one or more channels. For example, advertisers 102 can request that a purchasing incentive or advertisement under design be provided on the present channel or all channels by selecting (e.g., by clicking) the appropriate checkbox (or another selectable widget). In advertisement category section 406, advertisers 102 can select the type of any of purchasing incentives and advertisements being designed, which may automatically affect the options provided by other sections presented by GUI portion 400.

In at least one exemplary embodiment, advertisers 102 can select between simple, click-through and complex purchasing incentives/advertisements. Advertisers 102 can choose to design simple coupons where consumer data is released (or unlocked) for advertisers 102 once a particular consumer 104 prints (or, alternatively, views) the coupon. Each coupon can be assigned a unique identifier to prevent unauthorized duplications followed by attempted unauthorized redemptions by consumers 104. Advertisers 102 can be billed based on coupons printed, which may be based on a fixed fee. Advertisers 102 can also choose to design click-through purchasing incentives/advertisements, which purchasing incentives/advertisements can include hypertext links to websites or microsites of advertisers 102 in portions (e.g., text portions) thereof. System provider 106 can charge advertisers 106 different rates and/or rely on different revenue generating methods in providing click-through purchasing incentives/advertisements through the exemplary website.

Advertisers 102 can further choose to design complex purchasing incentives/advertisements. Complex purchasing incentives/advertisements can include hypertext links to websites or microsites of advertisers 102 in portions thereof. Once a website or microsite is reached, consumers 104 can be presented an offer that may require acceptance by consumers 104 via data entry and submission. As non-limiting examples, consumers 104 can be presented credit card offers, subscription service offers and the like. For instance, consumers 104 can view the complex purchasing incentives/advertisements via the exemplary system and can link to another website to complete the transaction. The exemplary system can track consumers 104 off-website in this instance to determine if the transaction is completed. These types of transactions are known to one having ordinary skill in the art and often involve advertisers 102 providing a unique offer identifier which the exemplary system can incorporate into the unique identifier for the complex purchasing incentive/advertisement. The unique identifier allows advertisers 102 and system provider 106 to audit each other. Alternatively, singularly or in conjunction, tracking is also achievable via cookies. System provider 106 can charge advertisers 106 different rates and/or rely on different revenue generating methods in providing complex purchasing incentives/advertisements through the exemplary website.

In advertisement product category section 408, advertisers 102 can choose at least one category most closely related to the products forming the subject matter of the purchasing incentive/advertisement under design. For example, advertisement product category section 408 can include a drop down menu or like GUI widgets for allowing advertisers 102 to choose a provided category. In template library section 410, advertisers 102 can be presented with preformatted purchasing incentive/advertisement templates to choose from. The templates provided by the system can be a function of the type and/or category of purchasing incentives chosen by advertisers 102 in advertisement type section 406 and advertisement product category section 408.

In image upload section 412, advertisers 102 can upload images for inclusion in the purchasing incentive/advertisement under design. An image or images can be transferred into a selected preformatted template during the design/build process by the system. In at least one exemplary embodiment, uploading images to the system can be simplified. A rule set can be imposed that can define the criteria for accepting images. A process for uploading images can include: advertiser 102 selects link (e.g., button) to upload image; advertiser 102 selects an image stored on the computing device of advertiser 102; advertiser 102 enters a caption describing the image; the system saves the caption to a storage device (e.g., database); the system uploads the image; the system resizes the image to a predetermined size; the system converts the image into a predetermined file type (e.g., JPEG), if not already in the predetermined file type; the system renames the image to a unique name; the system saves the image as the full-size image; and the system saves the width and height details of the image to a storage device (e.g., database). Such a process may provide a consistent user experience, which may not depend on individual images sizes and file types.

In header text entry section 414, advertisers 102 can enter a header for a purchasing incentive/advertisement under design. Header text can be transferred to a selected preformatted template by the system. In secondary text entry section 416, advertisers 102 can enter secondary text, which may add additional descriptive detail not found in the header. Secondary text can be transferred to a selected preformatted template by the system. In main text entry section 418, advertisers 102 can enter text directed to the body of their purchasing incentive/advertisement under design. Main text can be transferred to a selected preformatted template by the system. Main text can include, for example, hypertext links when entered for click-through and complex purchasing incentives/advertisements. One or more of text entry sections 414, 416, 418 can include standard formatting tools (e.g., save, paste, bold, italic, underline, left justify, right justify, center justify, number, bullet, indent, style, font, font/point size and the like)

In keyword section 420, advertisers 102 can enter one or more (e.g., three) keywords to associate the purchasing incentive/advertisement with during searches performed on the exemplary website by consumers 104. In advertisement file name section 422, advertisers 102 can enter a name for the purchasing incentive/advertisement under design.

By selecting preview link 424, advertisers 102 can link to a preview of the purchasing incentive/advertisement under design. The preview may be provided in pop-up form. The preview can populate a selected preformatted template with the data entered by advertisers 102 in GUI portion 400. After viewing the preview, advertisers 102 can return to sections of GUI portion 400 to edit the purchasing incentive/advertisement under design.

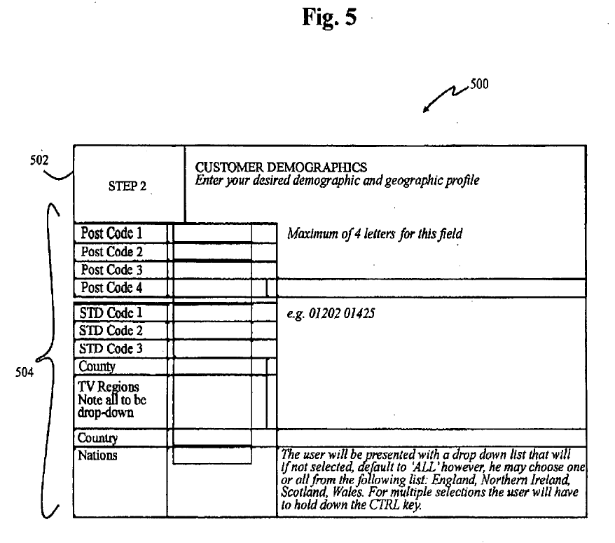

Referring particularly to FIG. 5, exemplary GUI portion 500 is illustrated. GUI portion 500 can be presented by at least one of webpage 344 and webpage 346, as non-limiting examples. GUI portion 500 can include step and title section 502 and consumer demographics section 504. Sections can be modified, rearranged, omitted and new sections added, as will be readily recognized by one having ordinary skill in the art.

In step and title section 502, GUI portion 500 can display information identifying the purpose (e.g., “customer demographics”) of portion 500 and the predetermined step (e.g., “step 2”) that portion 500 can be in an exemplary process. In consumers demographics section 504, demographic data for targeting consumers 104 can be entered by advertisers 102. As shown in a non-limiting manner, advertisers can enter data directed to one or more postal codes, town/city, one telephone STD/area codes, county, one or more TV regions, and states/nations. Other demographic data can include gender, age and the like. On the exemplary website, it is contemplated that consumers 104 can be-directed to any of purchasing incentives and advertisements based on demographic data (e.g., supplied during registration and may be editable thereafter). It is likewise contemplated that consumers 104 can search or otherwise find any of purchasing incentives and advertisements based on demographic data. Accordingly, GUI portion 500 can provide advertisers 102 with the ability to associate any of purchasing incentives and advertisements under design (or newly designed) with such demographic data, which can serve to target the potential customer base of advertisers 102.

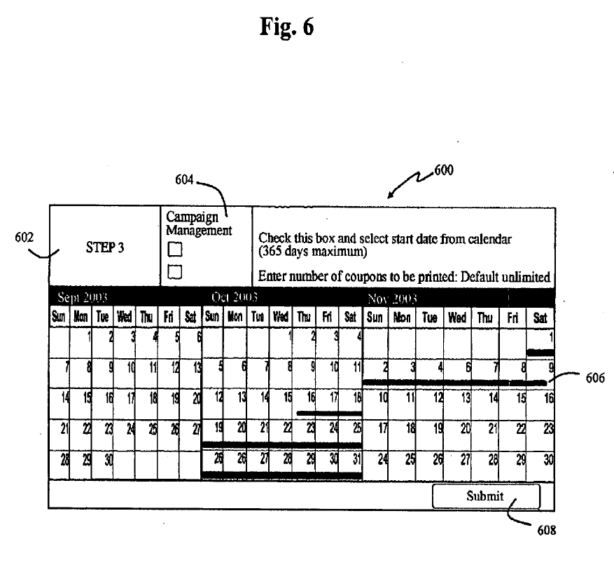

Referring to FIG. 6, exemplary GUI portion 600 is illustrated. GUI portion 600 can be presented by at least one of webpage 344, webpage 346 and webpage 348, as non-limiting examples. GUI portion can include step section 602, campaign management section 604, interactive calendar section 606 and submit link 608. Sections can be modified, rearranged, omitted and new sections added, as will be readily recognized by one having ordinary skill in the art.

In step section 602, GUI portion 600 can display the predetermined step (e.g., “step 3”) that portion 602 can be in an exemplary process. In campaign management section 604, advertisers 102 can be provided various GUI widgets for planning a promotional campaign. As shown in a non-limiting manner, advertisers 102 can be provided a checkbox (or another selectable widget) that can indicate that advertisers 102 are ready to select the calendar period in which the purchasing incentive/advertisement is to be provided via the exemplary system (i.e. published on the exemplary website). Advertisers 102 can also be provided a data entry field for limiting the number of coupons that can be printed by consumers 104. In interactive calendar section 606, advertisers can manipulate the interactive calendar to select a calendar period in which the purchasing incentive/advertisement is to be provided to consumers 104 via the system.

Submit link 608 (shown as a button) can be selected by advertisers 102 to complete the design of the purchasing incentive/advertisement and the setting of the promotional campaign parameters offered by exemplary GUI portions 400, 500, 600. Upon submission, the promotional campaign can be saved by the system and effectuated by the system on the start data selected via the interactive calendar. The promotional campaign and the purchasing incentive/advertisement thereof can be subjected to editing by advertisers 102 via the advertisers module 232 of the exemplary system.

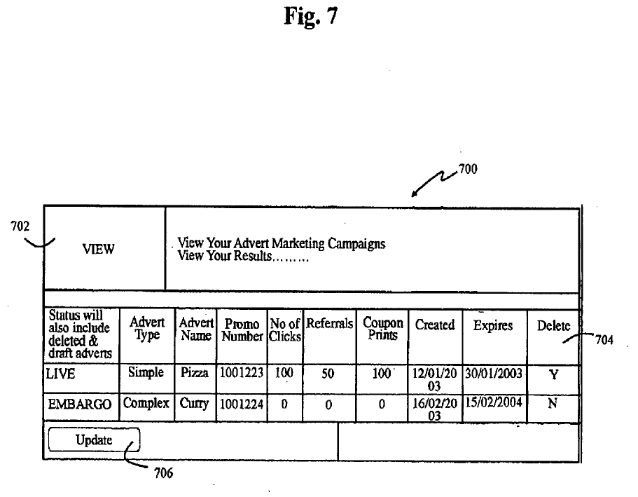

Referring to FIG. 7, exemplary GUI portion 700 is illustrated. GUI portion 700 can be presented by webpage 348 for managing, at least in part, promotional campaigns, as one non-limiting example. GUI portion can include title section 702, promotional campaign table section 704 and update/edit link 706. Sections can be modified, rearranged, omitted and new sections added, as will be readily recognized by one having ordinary skill in the art.

In title section 702, GUI portion 700 can display information for identifying the purpose (e.g., “view”, “view your advert marketing campaign . . . ,” etc.) of portion 702. In promotional campaign table section 704, a table identifying promotional campaigns of advertiser 102 can be provided. The table can have columns and/or rows. As shown, an exemplary table can have columns directed to campaign status (e.g., live, draft, embargo and deleted), type of purchasing incentive/advertisement (e.g., simple, click-through and complex), name of purchasing incentive/advertisement (also name of promotional campaign), number of clicks, number of referrals, number of coupons printed, creation date of campaign, expiration date of campaign and deletion status. Rows and columns can be modified, rearranged, omitted and new rows and columns added, as will be readily recognized by one having ordinary skill in the art. Appropriate data can populate the table for each reviewable promotional campaign of advertisers 102. Advertisers 102 can view predetermined information about each promotional campaign, which may aid advertisers 102 in making business decisions about particular promotional campaigns. Data populating the table can be updated in near real-time (and automatically or manually refreshable), which can allow advertisers 102 to track predetermined information about each promotional campaign.

In at least one exemplary embodiment, the promotional campaigns referenced by the table (indicia thereof) can be selectable by advertisers 102 within the table. Upon selection of a promotional campaign, advertisers 102 can further select update/edit link 706 (shown as a button) to be directed to one or more webpages for editing the promotional campaign. Promotional campaigns may also have their status changed to “deleted” by advertisers 102. The system may periodically and permanently delete campaigns designated as such. The one or more webpages can be or can be similar to webpages 344, 346, 350 of advertisers module 232. Also, the webpages can include GUI portions of FIGS. 4-6 (or GUI portions similar thereto) that can conjunctively provide advertisers 102 the ability to design, issue and edit promotional campaigns. For example, GUI portions can be pre-populated with data stored on the system for a promotional campaign. In another exemplary embodiment, update link 706 can simply act to refresh the table.

Referring generally to FIGS. 8-9, exemplary GUI portions for webpages at bulk email subportion 336 are illustrated. Referring to FIG. 8, exemplary GUI portion 800 can be presented by bulk email management webpage 354, as one non-limiting example. GUI portion 800 can include upload section 802, demographic selection section 804 and demographic data entry section 806. Sections can be modified, rearranged, omitted and new sections added, as will be readily recognized by one having ordinary skill in the art.

In upload section 802, advertisers 102 can add new files and folders regarding accessible consumers 104 (e.g., those consumers 104 who have printed coupons). The new files and folders can be added to consumer file and folders that have previously been uploaded by advertisers 102. From these files and folders, advertisers 102 can select to send emails to consumers 104 based on demographic data in demographic selection section 804. For example, advertisers 102 can select the checkboxes (or, alternatively, other GUI widgets) for sending email and for selecting demographics. In demographic data entry section 806, advertisers 102 can enter demographic data for targeting consumers 104 who have provided matching demographic data to the system. As shown, demographic data targeted by bulk email can include postal codes, cities/towns, telephone STD/area codes, counties, television regions and states/nations. Demographic data entry section 806 can also provide other types of demographic data entry, including gender, age and the like. Entry of demographic data can be by simple data entry into data entry boxes. Alternatively, drop down menus and like GUI widgets can be disposed on GUI portion 800.

Referring to FIG. 9, exemplary GUI portion 900 can be presented by any one of folder management webpage 356 and view folder webpage 358, as non-limiting examples. GUI portion 900 can include title section 902, folder addition section 904, file upload section 906 and folder viewer section 908. Sections can be modified, rearranged, omitted and new sections added, as will be readily recognized by one having ordinary skill in the art.

In title section 902, GUI portion 900 can display information for identifying the purpose (e.g., “view customer folders & upload from file”) of portion 900. In folder addition section 904, advertisers 102 can select to add a new folder and name the new folder. In file upload section 906, advertisers 102 can upload email files of accessible consumers 104, which can be provided by and on the exemplary system. Files can thus be uploaded to the accounts of registered advertisers 102. Files uploaded and located in the folders can be in Excel, Comma Separated Values (“CSV”) and Access formats, as non-limiting examples. Folders can also be assigned for each consumer 104 and, within such folders, others subordinate folders can be provided. For example, a coupon redemption folder under a consumer folder can contain files having data regarding number and/or types of coupons printed. A referral folder under a consumer folder can contain files having data regarding coupons shared by each consumer 104 with other registered or unregistered consumers 104, for example, by email. In folder viewer section 908, folders can be presented to advertisers 102. Advertisers 102 can also choose to view or delete folders in folder viewer section 908 by selecting the appropriate hypertext link. In at least one exemplary embodiment, in folder viewer section 908, advertisers 102 can determine accessible consumers 104 who have printed or referred coupons by linking to webpages presenting such information. Folder viewer section 908 can be styled as a table for referencing consumer names, email addresses, number of referrals, number of coupons printed and the unique identifiers for coupons printed, as non-limiting examples.

In at least one exemplary embodiment, the exemplary system can periodically send emails to advertisers 102 regarding one or more promotional campaigns, particularly, active promotional campaigns. Emails can include any type of information in various formats about the one or more promotional campaigns and can contain hypertext links to any webpages of advertisers module 232. GUI portions of advertiser module 232 can also be embedded in emails. As one non-limiting example, GUI portion 900 (or sections thereof) can be embedded in an email to advertisers 102 for allowing the advertiser to view folders, files and associated information about accessible consumers 104.

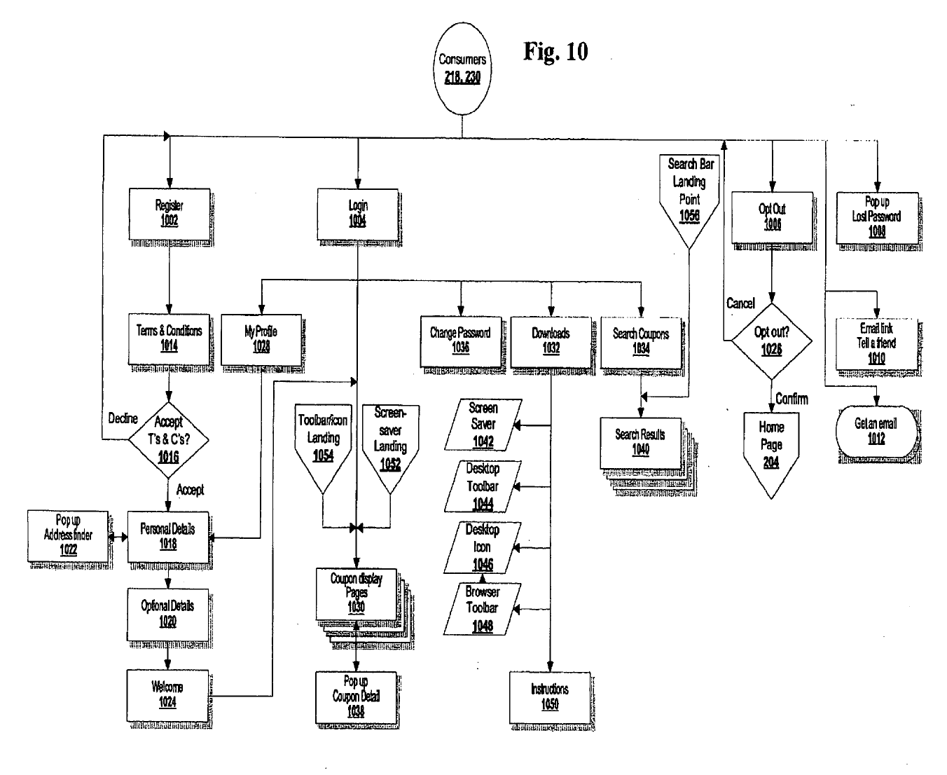

Referring to FIG. 10, exemplary consumers module 230 is illustrated as a portion of the exemplary website. At consumers home webpage 218 of consumers module 230, hypertext links can be presented to consumers 104 for registration subportion 1002, logged-in consumers subportion 1004 and de-registration (opt out) subportion 1006. At consumers home webpage 218, any hypertext link known to one having ordinary skill in the art can be included, such as lost password link 1008 and email link 1010 for directing consumers 104 to associated webpages and features. External email registration link 1012 can also be included, which can direct consumers 104 to the website of a popular email account provider (e.g., MICROSOFT HOTMAIL, GOOGLE GMAIL, YAHOO! MAIL, etc.).

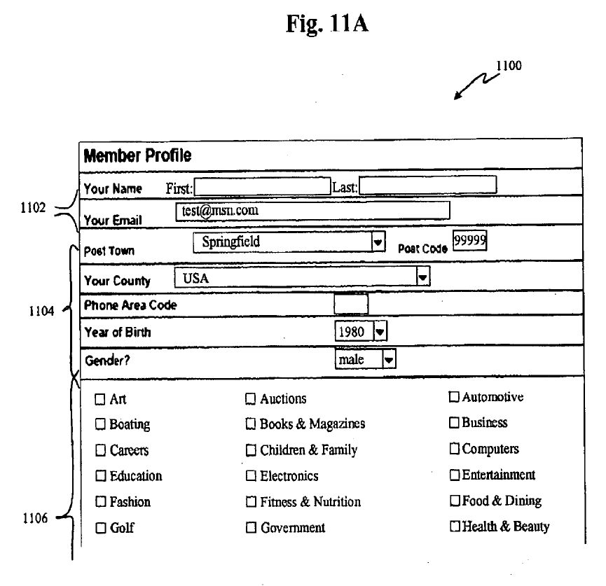

At registration subportion 1002, consumers 104 can be presented with terms and conditions webpage 1014 and can accept the terms and conditions at decision 1016. At webpages 1018, 1020, consumers 104 can enter a variety of required and optional data, including contact data (e.g., names and email addresses), demographic data, categorical data and the like. Webpages 1018, 1020 can be combined into a single webpage or expanded to more than two webpages, as will be readily recognized by one having ordinary skill in the art. Webpages 1018, 1020 can be presented to consumers 104 in form format with various GUI widgets for entering data. As described further below, FIGS. 11A and 11B jointly show an exemplary GUI portion that may be presented to consumers 102 by webpages 1018, 1020 (or a combination thereof) of registration subportion 1002. Data entered by consumers 104 can be validated by the system. Data can also be limited to predetermined lengths and types of alphanumeric characters, and can be requested in particular formats. Webpages 1018, 1020 can be later accessed by registered consumers 104 for updating and editing account information where webpages 1018, 1020 can be pre-populated with stored data.

Webpages 1018, 1020 can also be linked to additional webpages for assisting consumers 104 in entering information or can provide separate webpages for entering types of information. For example, address finder webpage 1022 can be linked to account information webpage 1018 for providing consumers 104 with address identification functionality. Upon registration, consumers 104 can be directed to and presented with welcome webpage 1024 of logged-in subportion 1004.

In any of weppages 1018, 1020, consumers 104 can be presented with preformatted forms for entering contact data and demographic data, as well as, selecting categories/areas of interest from the predetermined options. After registration and at logged-in subportion 1004, logged-in consumers 104 can be automatically presented any of purchasing incentives and advertisements (e.g., coupons) associated with the demographic and/or categorical data matching such data entered by consumers 104 during registration. Thus, consumers 104 can be demographically- and/or categorically-targeted. Consumers 104 may be able to search for or otherwise find other non-matching or matching purchasing incentives/advertisements in at least one exemplary embodiment.

If any registered consumers 104 decide they no longer desire to be registered users of the exemplary system, consumers 104 can link to de-registration (opt out) subportion 1006. At de-registration subportion 1006, consumers 104 can be presented with opt out decision 1026. If consumers 104 select to opt out, then consumers 104 can be directed to home webpage 204. The exemplary system can de-register such consumers 104 by, for example, suspending or deleting their accounts.

Still referring to FIG. 10, logged-in consumers portion 1004 can be for registered and logged-in consumers 104. Consumers 104 can login from one or more webpages, including consumers home webpage 218 of consumers module 230. Consumers 104 can login by entering an account name or number (e.g., email address or other unique identifier) and a password that can be validated by the system. Consumers 104 can also have login data saved and can be automatically logged-in by, for example, enabled identification cookies programmed to do so, as is well known in the art. Once logged-in, registered consumers 104 can be presented with a webpage. The webpage, which may be webpage 1024 or similar thereto, can include hypertext links for directing consumers 104 to profile subportion 1028, purchasing incentive/advertisement display subportion 1030, downloads subportion 1032 and search subportion 1034. At logged-in subportion 1004, consumers 104 can also be provided the ability to track coupons printed in at least one exemplary embodiment. At profile subportion 1028, consumers 104 can be presented with or link to any of consumers account information webpages 1018, 1020 where consumers 104 can edit and update account information. As described above, any of webpages 1018, 1020 can be pre-populated with stored account data regarding consumers 104, which may then be edited. At password webpage 1034, which may be provided in profile subportion 1028 or elsewhere (as shown), consumers 104 can change the current password to their account where the original password may have been selected and/or assigned during the registration process.

At purchasing incentive/advertisement display subportion 1030, one or more webpages including, or including hypertext links to, any of a plurality of purchasing incentives or a plurality of advertisements can be provided to consumers 104 from advertisers 102 via the exemplary website. In at least one exemplary embodiment, a plurality of coupons or hypertext links thereto can be published and listed on the one or more webpages viewable by consumers 104 operating client computing devices. Also, in at least one exemplary embodiment, the plurality of purchasing incentives/advertisements (or hypertext links thereto) can be published by the exemplary system based on whether demographic and/or categorical data associated with the purchasing incentives/advertisements matches the current demographic and categorical data stored for the accounts of consumers 104. Moreover, in at least one exemplary embodiment, consumers 104 can select a hypertext link (which may be in the form of a single line description) for a coupon and can be directed to webpage 1038 showing the selected coupon in a viewable manner.

At purchasing incentive/advertisement display subportion 1030 (e.g., via webpage 1038), a particular consumer 104 can print a selected purchasing incentive, such as a coupon. Accordingly, the status of consumer 104 can be flagged by the exemplary system so that contact and demographic (and/or categorical) data for consumer 104 can be made accessible (or unlocked) to a particular advertiser 102 who provided the coupon printed. Consumer 104 can be flagged as a “customer” of advertiser 102.

At search subportion 1034, consumers 104 can be provided search functionality for returning a plurality of any of purchasing incentives and advertisements on one or more results webpages 1040. Search subportion 1034 may also be linked to from purchasing incentive/advertisement display subportion 1030. Search functionality can rely on keyword searching or, alternatively, singularly or in conjunction, searching can be performed by demographic, categorical and like data. In at least one exemplary embodiment, consumers 104 can view (or link to viewable) coupons listed on one or more webpages 1040. Consumers 104 can print a selected purchasing incentive, such as a coupon. Accordingly, the status of consumer 104 can be flagged by the exemplary system so that contact and demographic (and/or categorical) data for consumer 104 can be made accessible (or unlocked) to a particular advertiser 102 who provided the coupon printed. Consumer 104 can be flagged as a “customer” of advertiser 102.

At either or both of purchasing incentive/advertisement display subportion 1030 and search subportion 1034, any of purchasing incentives and advertisements can be hierarchally-arranged on webpages. Consumers 104 can find any of purchasing incentives and advertisements by linking within the hierarchy. Any of purchasing incentives and advertisements can be placed within categories and subcategories of the hierarchy. The categories and subcategories can be the same as those provided to advertisers 102 for associating any of purchasing incentives and advertisements with. Alternatively, singularly or in conjunction, categories and subcategories for consumers 104 can be more generalized and purchasing incentives/advertisements associated with categories and subcategories by advertisers 102 can be automatically sorted and placed within the more generalized hierarchy by the exemplary system.

At downloads subportion 1032, consumers 102 can download files for installing various locally stored tools for interacting with the exemplary system. As a few non-limiting examples, consumers 102 can download and install files 1042, 1044, 1046, 1048 for a screen saver tool, a desktop toolbar, a desktop icon and browser toolbar, respectively. Webpage 1050 can provide instructions and information in regard to downloading and installing such tools.

The screen saver tool can serve as a screen saver for when the computing devices of consumers 104 are idle. The screen saver tool can display any of purchasing incentives and advertisements, which may be provided based on the current demographic and/or categorical data stored for accounts of consumers 104. Any of purchasing incentives and advertisements can be updated when the computing devices of consumers 104 are connected to network 100. In at least one exemplary embodiment, consumers 104 can select coupons for viewing and/or printing by selecting a coupon (or hypertext link thereto) displayed by the screen saver tool. Accordingly, consumers 104 can select coupons and be directed to screen saver tool landing 1052. If consumers 104 are not connected to network 100, then consumers 104 can be prompted to connect to network 100. Once connected, it can be determined whether the selected coupon remains valid before allowing consumers 104 to print the coupon. As with the exemplary system as a whole, the screen saver tool can prevent consumers 104 from capturing the display coupons as an image file, which could later be printed and duplicated without authorization.

The desktop toolbar can be provided on the desktop of computing devices operated by consumers 104. For example, the desktop toolbar can minimize to the taskbar of an operating system (e.g., MICROSOFT WINDOWS operating systems). Any of purchasing incentives and advertisements can be displayed in reduced size within the desktop toolbar. In at least one exemplary embodiment, any of purchasing incentives and advertisements can be displayed in a scrolling manner within the desktop toolbar. Also, in at least one exemplary embodiment, consumers 104 can select a displayed coupon (or hypertext link thereto) for viewing and/or printing the coupon. Accordingly, consumers 104 can select coupons and be directed to desktop landing 1054. The status of the consumers 104 connection to network 100 can be determined and connection can be prompted for when needed. The status of the coupon can also be determined if consumers 104 are newly connected to network 100. Coupons can be protected against unauthorized printing and reproduction.

The desktop icon can be a selectable icon that resides on the desktop of computing devices operating by consumers 104. By selecting (e.g., clicking on) the desktop icon, consumers 104 can access any of home webpage 204, consumers home webpage 218, logged-in subportion 1004 of consumers module 230 and the like. Consumers 104 can also be directed to desktop landing 1054. Consumers 104 can login to the system by entering an account name or number (e.g., email address or other unique identifier) and a password that can be validated by the system. Consumers 104 can also have login data saved and can be automatically logged-in by, for example, enabled identification cookies programmed to do so, as is well known in the art.

The web browser toolbar can be a toolbar embedded within a web browser for carry out searches. The browser toolbar can allow consumers 104 to carry out searches based on keywords, demographic and/or categorical data with or without being first logged-in to the exemplary system. Upon entering a search, consumers 104 can be directed to browser toolbar landing 1056 and can be presented one or more results webpages 1040. In at least one exemplary embodiment, before viewing and/or printing coupons, consumers 104 can be required to be registered and logged-in.

Referring to FIGS. 11A and 11B, exemplary GUI portion 1100 for one or more webpages at registration subportion 1002 is illustrated. GUI portion 1100 can be presented by any of webpages 1018, 1020 (or, for example, as a single webpage containing elements thereof) to consumers 104, as non-limiting examples. GUI portion 1100 can include contact data section 1102, demographic data section 1104 and categorical data section 1106. Some data entered in sections 1102, 1104, 1106 can serve as more than one of contact, demographic and categorical data. Sections of GUI portion 1100 can be modified, rearranged, omitted and new sections added, as will be readily recognized by one having ordinary skill in the art.

In contact data section 1102, consumers 104 can enter various types of contact information using GUI widgets. As shown, consumers 104 can enter first and last names and an email address into the presented data entry boxes. In demographic data section 1104, consumers 104 can enter various types of demographics using GUI widgets. As shown, consumers 104 can enter town/city, postal/zip code, county/state, telephone area code, year of birth and gender, as non-limiting examples, using both data entry boxes and drop down menus having predetermined options. In categorical data section 1106, consumers 104 can enter various types of information regarding categories/areas of interest. As shown, consumers 104 can accomplish this by selecting checkboxes (or other selectable widgets) for categories/areas of interest among predetermined options. The categories/areas of interest options may be presented under sections pertaining to a more generalized category that the selectable categories/areas of interest are grouped under.

At logged-in portion 1004, GUI portion 1100 can also be presented and can be pre-populated with saved data for the accounts of consumers 104, which may be edited and updated.

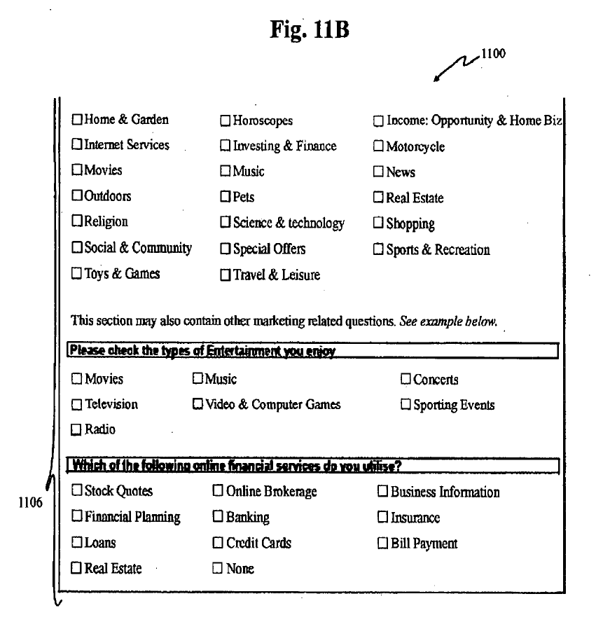

Referring to FIG. 12, exemplary channel partners module 236 is illustrated as a portion of the exemplary website. At channel partners home webpage 224 of channel partners module 236, a hypertext link can be presented to channel partners 108 for logged-in channel partners subportion 1202. At channel partners home webpage 224, any hypertext link known to one having ordinary skill in the art can be presented, such as site map link 1204, email link 1206 and lost password link 1208 for directing channel partners 108 to associated webpages and features. Although not shown, channel partners 108 can register with the system in a manner similar to the registration processes for advertisers 102 and consumers 104. Alternatively, channel partners 106 can be registered by system providers 106 at system provider module 238.

Logged-in channel partners subportion 1202 can be for registered and logged-in channel partners 108. Channel partners 108 can login from one or more webpages, including channel partners home webpage 224 of channel partners module 236. Channel partners 108 can login by entering an account name or number (e.g., email address, customer number or other unique identifier) and a password that can be validated by the system. Channel partners 108 can also have login data saved and can be automatically logged-in by, for example, enabled identification cookies programmed to do so, as is well known in the art. Once logged-in, registered channel partners 108 can be presented with welcome webpage 1210. Welcome webpage 1210 can include hypertext links for directing channel partners 108 to options subportion 1212, promotional (marketing) campaign subportion 1214, bulk email subportion 1216, reports subportion 1218, payment subportion 1220 and administrative (search and maintenance) subportion 1222.

At option subportion 1212, channel partners 108 can be presented with update registration information webpage 1224 and password webpage 1226 where channel partners 108 can edit and update account information and can change the current password to their account, respectively. Webpage 1224 can be pre-populated with stored account data regarding channel partners 108, which may then be edited. Address finder webpage 1228 can also be linked to update registration information webpage 1224, among others, for providing channel partners 108 with address identification functionality.

At promotional (marketing) campaign subportion 1214, channel partners 108 can build (design) any of purchasing incentives and advertisements with the same or similar functionality as subportion 332 of advertisers module 232. Channel partners 108 can also plan and manage a promotional campaign. By planning and managing a promotional campaign, channel partners 108 can determine the criteria in which any of purchasing incentives and advertisements are distributed and, thus, provided to consumers 104. At promotional campaign subportion 1214, at least one webpage 1230 can have aspects directed to building/designing any of purchasing incentives and advertisements. At least one webpage 1232 can have aspects directed to planning promotional campaigns. At least one webpage 1234 can have aspects directed to managing promotional campaigns, which may include features for terminating promotional campaigns, or, alternatively, at least one webpage 1236 can have aspects directed to terminating promotional campaigns. As described above, FIGS. 4-7 show exemplary GUI portions that may be presented to channel partners 108 by webpages 1230, 1232, 1234, 1236 of promotional campaign subportion 1214.

At bulk email subportion 1216, channel partners 108 can be presented at least one webpage 1238 directed to email templates. The email templates can be preformatted and selectable by channel partners 108. Upon template selection, channel partners 108 can be directed to at least one webpage 1240 for populating the template with data supplied and entered by channel partners 108. Other webpages can also be included to provide channel partners 108 with the ability to manage folders, view folders and view files. Bulk email subportion 1216 can provide channel partners 108 with the ability to send a plurality of emails to a plurality of consumers 104 while providing each consumer 104 with the ability to opt out of such bulk mailings. Bulk email functionality can provide channel partners 108 with the means to send consumers 104 new purchasing incentives, advertisements, general information and the like by email.

In at least one exemplary embodiment, the system can provide a particular channel partner 108 the ability to email registered consumers 104 who have printed one or more coupons of such channel partner 108 (or advertisers 102 associated with channel partner 108). The system can provide access to such consumers 104 based on contact data (including at least email addresses) entered by consumers 104 during a consumer registration process. Demographic and/or categorical data can also be collected from consumers 104 during the consumer registration process, which can be used in targeting bulk emails based on such demographic and/or categorical data. By collecting contact and demographic (and/or categorical) data, channel partners 108 can have the ability to follow-up with consumers 104 who have showed interest in the products of channel partners 108 (or their advertisers 102). At bulk email subportion 1216, channel partners 108 can also have the ability to access (or unlock) consumer contact data (including at least email addresses) and, optionally, known demographic and/or categorical data of consumers 104 already known to channel partners 108.

At reports subportion 1218, channel partners 108 can be presented with at least one campaign chart webpage 1242. In at least one exemplary embodiment, at campaign chart webpage 1242, channel partners 108 can view all consumers 104 that have printed and/or referred (shared) coupons. For example, webpage 1242 can include a table showing consumer data, such as names, email addresses, number of coupons printed, number of coupons referred, unique coupon identifiers associated with each coupon and the like. Webpage 1242 can link to webpage 1244. Webpage 1244 can include a campaign duration chart. The campaign chart can present the dates that a promotional campaign(s) is scheduled to run for. Reports subportion 1218 can include webpages 1246, 1248 directed to summary reports and ranking reports, respectively, and the like known to one having ordinary skill in the art. Each report webpage 1246, 1248 can further include links to one or more webpages 1250, 1252 for viewing further details of the respective reports.

At payment subportion 1220, channel partners 108 can be presented with payment report webpage 1254 directed to at least one payment report. Payment report webpage 1254 can further include hypertext links to one or more webpages 1256 for viewing further details of the at least one payment report. Payment subportion 1220 can also include one or more webpages directed to payment matters if system provider 106 determines that channel providers 108 should be charged for self-created purchasing incentives/advertisements.

At administrative (search and maintenance) subportion 1222, channel partners 108 can be presented administrator creation webpage 1258 for authorizing user (administrative) accounts for employees and others. User accounts may have different levels of access to features and functionalities of channel partners module 236. Account information, such as company (or other organization) and personal data, can be entered on one or more webpages, including webpage 1260. Also, at administration subportion 1222, channel partners 108 can be provided administrative search functionality, which may query at least one local or remote storage device (e.g., database) in returning results. Channel partners 108 can be presented any of advertisers search webpage 1262, administrator search webpage 1264, promotional campaigns search webpage 1266 and consumer (customer) search webpage 1268. Search results can be returned on webpages 1270, 1272, 1274, 1276. Further details of search results can be linked to and presented on webpages 1278, 1280, 1282, 1284. Modify promotional campaign webpage 1286 can also be linked to by channel partners 108 for editing and updating promotional campaigns. Promotional campaigns can also be viewed, searched, further details found and modified at webpages 1288, 1290, 1292, 1294, respectively, which may be the same or similar to webpages 1266, 1274, 1282, 1286.

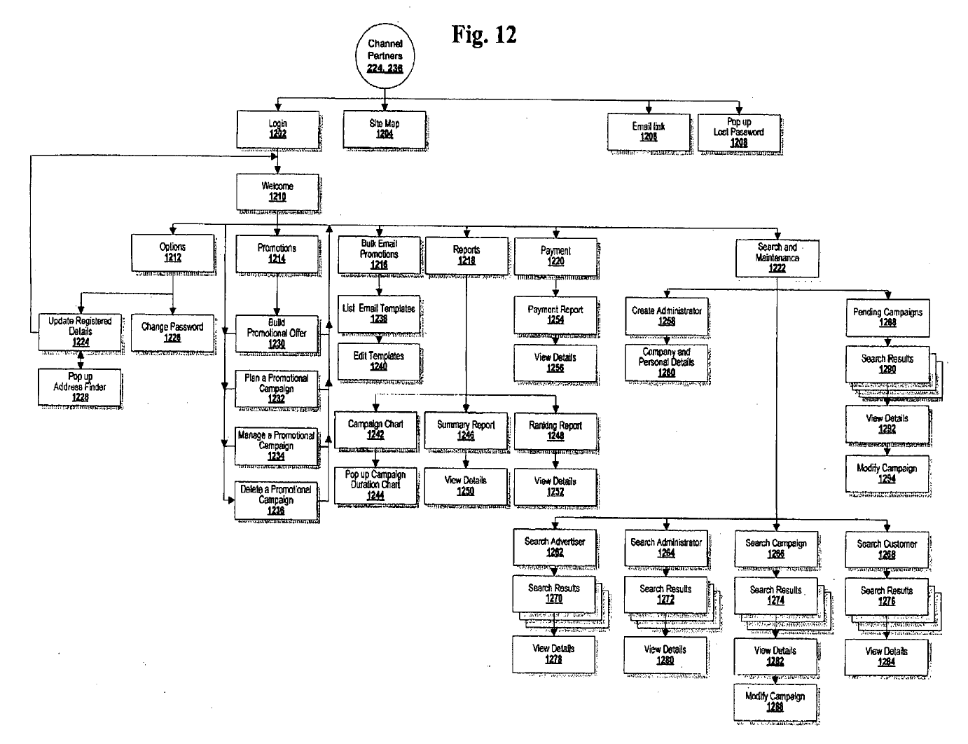

Referring to FIG. 13, exemplary affiliates module 234 is illustrated as a portion of the exemplary website. At affiliates home webpage 222 of affiliates module 234, hypertext links can be presented to affiliates for registration subportion 1302, logged-in affiliates subportion 1304 and de-registration subportion 1306. At affiliates home webpage 222, any hypertext link known to one having ordinary skill in the art can also be included, such as site map link 1308, email link 1310 and lost password link 1312 directing affiliates to associated webpages and features.

At registration subportion 1302, affiliates can be presented with terms and conditions webpage 1314 and can accept the terms and conditions at decision 1316. Upon accepting the terms and conditions, affiliates can be presented affiliates account information (e.g., business, user and financial information) webpage 1318. At webpage 1318 (or, alternatively, at webpage 314), each unregistered affiliate can enter an email address and can enter an account password selected by the affiliate. At webpage 1318, affiliates can enter a variety of account data, including company (or other organization) information and company (or other organization) member information for individual users. Webpage 1318 can be presented to affiliates in form format with various GUI widgets for entering data. Data entered by affiliates can be validated by the system. Data can also be limited to predetermined lengths and types of alphanumeric characters, and can be requested in particular formats. Data can also be limited to predetermined options. Webpage 1318 can be later accessed by registered affiliates for updating and editing information where webpage 1318 can be pre-populated with stored account data.

Webpage 1318 can also be linked to additional webpages for assisting affiliates in entering information or to provide separate webpages for entering types of information. For example, address finder webpage 1320 can be linked to for providing affiliates with address identification functionality.

If any registered affiliates decide that they no longer desire to be registered users of the exemplary system, affiliates can link to de-registration subportion 1306. At de-registration subportion 1306, affiliates can be presented with de-register decision 1322. If affiliates select to de-register, then affiliates can be directed to home webpage 204. The exemplary system can de-register such affiliates by, for example, suspending or deleting their accounts.

Still referring to FIG. 13, logged-in affiliates subportion 1304 can be for registered and logged-in affiliates. Affiliates can login from one or more webpages, including affiliates home webpage 222 of affiliates module 234. Affiliates can login by entering an account name or number (e.g., email address, customer number or other unique identifier) and a password that can be validated by the system. Affiliates can also have login data saved and can be automatically logged-in by, for example, enabled identification cookies programmed to do so, as is well known in the art. Once logged-in, registered affiliates can be presented with welcome webpage 1324. Welcome webpage 1324 can include hypertext links for directing affiliates to options subportion 1326, promotional (marketing) campaign subportion 1328, bulk email subportion 1330, reports subportion 1332, payment subportion 1334, other promotional/merchadizing material subportion 1336 and administrative (search and maintenance) subportion 1338.

At option subportion 1326, affiliates can be presented with affiliates account information webpage 1318 where affiliates can edit and update account information. As described above, webpage 1318 can be pre-populated with stored account data regarding an affiliate, which may then be edited. At password webpage 1340, affiliates can change the current password to their account where the original password may have been selected and/or assigned during the registration process.

At promotional (marketing) campaign subportion 1328, affiliates can build (design) any of purchasing incentives and advertisements with the same or similar functionality as subportion 332 of advertisers module 232. Affiliates may be provided additional features and functionalities as affiliate users may be expected to have greater technical savvy than advertisers 102. Affiliates can also plan and manage a promotional campaign. By planning and managing a promotional campaign, affiliates can determine the criteria in which any of purchasing incentives and advertisements are distributed and, thus, provided to consumers 104. At promotional campaign subportion 1328, at least one webpage 1342 can have aspects directed to building/designing any of purchasing incentives and advertisements. At least one webpage 1344 can have aspects directed to planning promotional campaigns. At least one webpage 1346 can have aspects directed to managing promotional campaigns, which may include features for terminating promotional campaigns, or, alternatively, at least one webpage 1348 can have aspects directed to terminating promotional campaigns. As described above, FIGS. 4-7 show exemplary GUI portions that may be presented to affiliates by webpages 1342, 1344, 1346, 1348 of promotional campaign subportion 1328.

At bulk email subportion 1330, affiliates can be presented at least one webpage 1350 directed to managing bulk email promotions. Webpages 1352, 1354, 1356 can also be included to provide affiliates with the ability to manage folders, view folders and view files, respectively. Bulk email subportion 1330 can provide affiliates with the ability to send a plurality of emails to a plurality of consumers 104 while providing each consumer 104 with the ability to opt out of such bulk mailings. Bulk email functionality can provide affiliates with the means to send consumers 104 new purchasing incentives, advertisements, general information and the like on behalf of advertisers 102 by email. Webpage 1358 can also be provided for managing more than one bulk email campaign.

In at least one exemplary embodiment, the system can provide an affiliate the ability to email registered consumers 104 who have printed one or more coupons of a particular advertiser 102. The system can provide access to such consumers 104 based on contact data (including at least email addresses) entered by consumers 104 during a consumer registration process. Demographic and/or categorical data can also be collected from consumers 104 during the consumer registration process, which can be used in targeting bulk emails based on such demographic and/or categorical data. By collecting contact and demographic (and/or categorical) data, affiliates can have the ability to follow-up with consumers 104 on behalf of advertisers 102.

Also, in at least one exemplary embodiment, affiliates can access contact and demographic (and/or categorical) data of such consumers 104. Folders can be created by affiliates for storing consumer data. Files uploaded and located in the folders can be in Excel, Comma Separated Values (“CSV”) and Access formats, as non-limiting examples. As described above, FIG. 9 shows an exemplary GUI portion, which may be presented by webpage 1352 (or view folder webpage 1354). View folder webpage 1354 can present all folders accessible to the affiliate. Folders can also be assigned for each consumer 104 and, within such folders, others subordinate folders can be provided. For example, a coupon redemption folder under a consumer folder can contain files having data regarding number and/or types of coupons printed. A referral folder under a consumer folder can contain files having data regarding coupons shared by each consumer 104 with other registered or unregistered consumers 104, for example, by email.

Moreover, in at least one exemplary embodiment, bulk email subportion 1330 can provide functionality enabling affiliates to select demographic (and/or categorical) criteria that affiliates/advertisers 102 desire to target by a bulk email campaign. For example, demographic data targeted by bulk email can include any of postal codes, cities/towns, telephone STD/area codes, counties, television regions, states/nations and the like. For the convenience of consumers 104, every email generated by bulk email subportion 1330 can contain an opt out (unsubscribe) link. Accordingly, consumers 104 can opt out of promotional email campaigns of a particular advertiser 102. As further described below, FIG. 8 shows an exemplary GUI portion (of, for example, webpage 354) for demographically-targeting consumers 104.

At reports subportion 1332, affiliates can be presented with at least one campaign chart webpage 1360. In at least one exemplary embodiment, at campaign chart webpage 1360, affiliates can view all consumers 104 that have printed and/or referred (shared) coupons of advertisers 102. For example, webpage 1360 can include a table for each advertiser 102 showing consumer data, such as names, email addresses, number of coupons printed, number of coupons referred, unique coupon identifiers associated with each coupon and the like. Webpage 1360 can link to webpage 1362. Webpage 1362 can include a campaign duration chart for a particular campaign of a particular advertiser 102. The campaign chart can present the dates that a promotional campaign(s) is scheduled to run for. Reports subportion 1332 can include webpage 1364 directed to summary reports, as well as other webpages directed to like reports known to one having ordinary skill in the art. Summary report webpage 1364 can further include a link to one or more webpages 1366 for viewing further details of the summary reports.

At payment subportion 1334, affiliates can be presented with payment report webpage 1368 directed to at least one payment report. Payment report webpage 1368 can further include links to one or more webpages 1370 for viewing further details of the at least one payment report. Payment subportion 1220 can also include one or more webpages directed to payment matters if affiliates are making payments on behalf of advertisers 102.

Still referring to FIG. 13, at other promotional/merchandizing materials subportion 1336, one or more webpages 1372 can provide affiliates with the ability to design any of leaflets, flyers, business cards and like point-of-sale materials on behalf of advertisers 102. One or more webpages 1372 can include templates for designing such point-of-sale materials. While promotional campaign subportion 1328 can be directed, at least in part, to designing any of purchasing incentives and advertisments provided to consumers 104 via the exemplary website, other materials subportion 1336 can be directed to providing electronic documents that affiliates can create for advertisers 102 or themselves for off-website uses.

At administrative (search and maintenance) subportion 1338, affiliates can be presented advertisers creation webpage 1374 for registering and/or adding advertisers 102 that affiliates are acting on behalf of. Account information, such as company (or other organization) and personal data, can be entered on one or more webpages, including webpage 1376. Webpage 1376 can also be linked to additional webpages for assisting affiliates in entering information or to provide separate webpages for entering types of information. For example, address finder webpage 1378 can be linked to for providing affiliates with address identification functionality. Business types webpage 1380 can be presented to affiliates for selecting one or more categories of business types which most closely described the businesses of advertisers 102.

At administrative subportion 1338, affiliates can be presented affiliate users creation webpage 1382 for authorizing user accounts for employees and others. User accounts may have different levels of access to features and functionalities of affiliates module 234. Account information, such as personal data, can be entered on one or more webpages, including webpage 1384. Also, at administration subportion 1338, affiliates can be provided administrative search functionality, which may query at least one remote storage device (e.g., database) of system provider 106 in returning results. Affiliates can be presented any of advertisers search webpage 1386, affiliate search webpage 1388 and promotional campaigns search webpage 1390. Search results can be returned on webpages 1392, 1394, 1396. Further details of search results can be linked to and presented on webpages 1393, 1395, 1397.

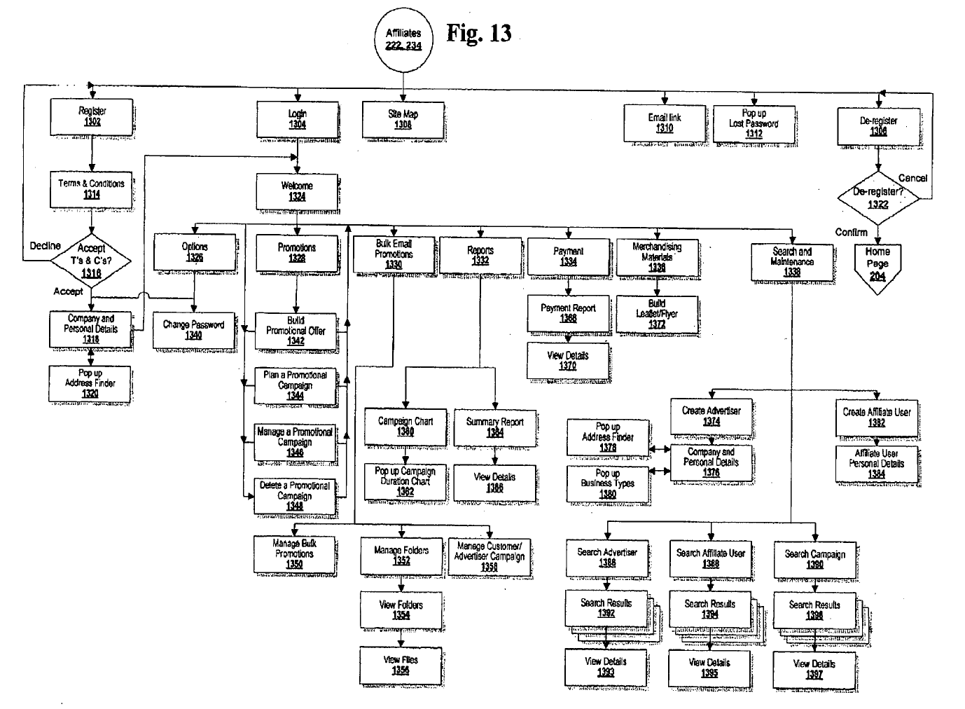

Referring to FIG. 14, exemplary system provider module 238 is illustrated as a portion of the exemplary website, which may reside on a non-public and secured portion of the exemplary website. Alternatively, system provider module 238 may be accessible like modules 230, 232, 234, 236. Modules 230, 232, 234, 236 can also be secured portions upon login as is known to one having ordinary skill in the art. At system provider module 238, a hypertext link can be presented to system administrators for logged-in system provider subportion 1401. Any hypertext link known to one having ordinary skill in the art can also be included, such as site map link 1402, email link 1403 and lost password link 1404 directing system administrators to associated webpages and features. For example, email link 1403 can link to a user's default email program for sending a new message to a predetermined email address of system provider 106.

Logged-in system provider subportion 1401 can be for registered and logged-in system administrators. System administrators can have differing levels of authorized access with some super administrators having access to all features and functionalities of logged-in subportion 1401 and other administrators having access to predetermined features and functionalities. System administrators can login by entering an account name or number (e.g., email address, administrator number or other unique identifier) and a password that can be validated by the system. System administrators can also have login data saved and can be automatically logged-in by, for example, enabled identification cookies programmed to do so, as is well known in the art. Once logged-in, system administrators can be presented with welcome webpage 1405. Welcome webpage 1405 can include hypertext links for directing administrators to options subportion 1406, bulk email subportion 1407, administrative (search and maintenance) subportion 1408, channel partners payment subportion 1409, affiliates payment subportion 1410, advertisers payment reports subportion 1411 and reports subportion 1412.

At option subportion 1406, administrators can be presented with update registration information webpage 1413 and password webpage 1414 where administrators can edit and update account information and can change the current password to their account, respectively. Webpage 1413 can be pre-populated with stored account data regarding administrators, which may then be edited.

At bulk email subportion 1407, administrators can be presented at least one webpage 1415 directed to system provider email templates. The email templates can be preformatted and selectable by administrators. Upon template selection, administrators can be directed to at least one webpage 1416 for editing/populating the template with data supplied and entered by administrators. Administrators can also be presented at least one webpage 1417 directed to advertisers (or channel partners or affiliates) email templates. Upon template selection, administrators can be directed to at least one webpage 1418 for editing the templates that will later be supplied to any of advertisers 102, channel partners 108 and affiliates. Other webpages can also be included to provide administrators with the ability to manage folders, view folders and view files. Bulk email subportion 1407 can provide administrators with the ability to send a plurality of emails to a plurality of advertisers 102, consumers 104, channel partners 108, affiliates and any other parties. Bulk email functionality can provide administrators with the means to send users any type of information desired.

At administrative (search and maintenance) subportion 1408, authorized administrators can be presented administrators creation webpage 1419 for adding administrators with, optionally, differing access authorizations. Account information, such as company (or other organization) and personal data, can be entered on one or more webpages, including webpage 1420.

At administrative subportion 1408, administrators can be provided search functionality, which may query at least one local or remote storage device (e.g., database) of system provider 106 in returning results. Administrators can be presented any of advertisers search webpage 1421, administrators search webpage 1422, promotional campaigns search webpage 1423, channel partners search webpage 1424, affiliates search webpage 1425 and consumers search webpage 1426. Search results can be returned on webpages 1427, 1428, 1429, 1430, 1431, 1432.

From search result webpages 1427, administrators can link to webpage 1433 for viewing further details of advertisers 102. Hypertext link 1434 can be linked to for emailing advertisers 102. From search results webpages 1428, authorized administrators can link to webpages 1435, 1436 for viewing further details of other administrators and modifying details of other administrators, respectively. Hypertext link 1437 can be linked to for emailing administrators. From search results webpages 1429, administrators can link to webpages 1438, 1439 for viewing further details of promotional campaigns and modifying details of promotional campaigns. Hypertext link 1440 can be linked to for emailing campaign creators (whether advertisers 102, channel partners 106 or any affiliates), respectively. From search results webpages 1430, administrators can link to webpages 1441, 1442, 1443, 1444, 1445 for viewing further details of channel partners 106, modifying details of channel partners 106, viewing details of users for channel partners 106, modifying details of users for channel partners 106 and address finder functionality, respectively. Hypertext link 1447 can be linked to for emailing channel partners. Webpage 1446 can be on the websites (hosted and unhosted portions) of channel partners 106. From search results webpages 1431, administrators can link to webpages 1448, 1449, 1450, 1451 for viewing further details of affiliates, viewing yet further details of affiliates, viewing users for affiliates and viewing further details of such users, respectively, Hypertext links 1452, 1453 can be linked to for emailing affiliates and users for affiliates, respectively. From search results webpages 1432, administrators can link to one or more webpages 1454 for viewing further details of consumers 104. Hypertext links 1455 can be linked to for emailing consumers 104. At administrative subportion 1408, other webpages can be provided, such as webpages 1456, 1457 for setting global variables and creating channel partners accounts, respectively. Channel partners account creation webpage 1457 can link to webpage 1458 for providing address finder functionality.

At channel partners payment subportion 1409, administrators can be presented with payment report webpage 1459 directed to at least one payment report. Webpages 1460, 1461, 1462 can be directed to viewing further details of such reports by advertisers, by promotional campaigns and by consumers, respectively.

At affiliates payment subportion 1410, administrators can be presented with payment report webpage 1463 directed to at least one payment report. Webpages 1464, 1465, 1466 can be directed to viewing further details of such reports by advertisers (or affiliates), by promotional campaigns and by consumers, respectively.

At advertisers payment subportion 1411, administrators can be presented with various webpages directed to payment-related reports and matters. Advertisers payment subportion 1411 can include webpages 1467, 1468, 1469, 1470, 1471, 1481 directed to online pre-payment details, offline payment details, invoice report, payment received reports, pre-payment reports and viewable invoice reports. Webpages 1469, 1470, 1471 can have search functionality and search results can be respectively returned on webpages 1473, 1474, 1475. Further details of information presented on webpages 1472, 1473, 1474, 1475 can be found at webpages 1476, 1477, 1478, 1479. From search results webpage 1472, administrators can link (directly or indirectly) to webpages 1480, 1481, 1482, 1483, 1484 for viewing further invoice details, pay now functionality, credit card payment functionality, debit card payment functionality and viewing further details of promotional campaigns.

At reports subportion 1412, administrators can be presented with at least one campaign chart webpage 1485. In at least one exemplary embodiment, at campaign chart webpages 1485, administrators can view all consumers 104 that have printed and/or referred (shared) coupons of particular advertisers 102. For example, webpages 1485 can include a table for each advertiser 102 showing consumer data, such as names, email addresses, number of coupons printed, number of coupons referred, unique coupon identifiers associated with each coupon and the like. Webpage 1485 can link to webpage 1486. Webpage 1486 can include a campaign duration chart for a particular campaign of a particular advertiser 102. The campaign chart can present the dates that a promotional campaign(s) is scheduled to run for.

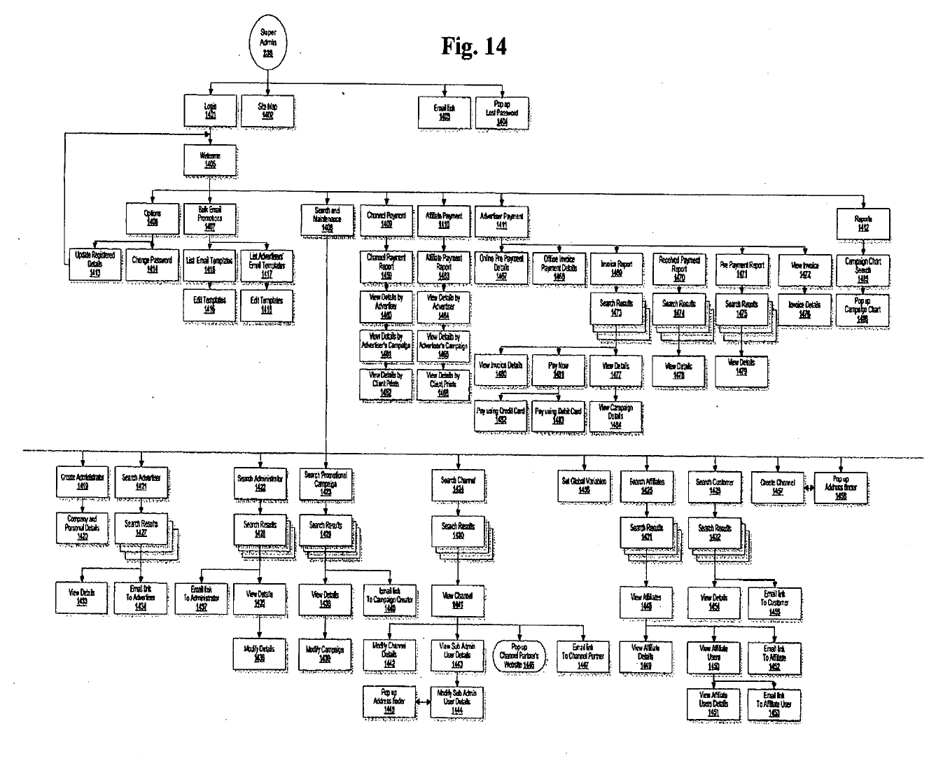

Referring to FIG. 15, an exemplary coupon in graphical (electronic) or printed form is illustrated. Exemplary coupon 1500 can include expiration date 1502, bar code 1504, unique identifier 1506, uploaded or stock image 1508, header text section 1510, secondary text section 1512 and main text section 1514. Expiration date 1502 can be supplied by the system in response to users selecting an end data for a promotional campaign via, for example, a campaign duration chart. Bar code 1504 can match the product codes of advertisers 102. In at least one exemplary embodiment, advertisers 102 can supply the bar code, for example, as an image file. Unique identifier can uniquely identify each coupon and can also contain a portion uniquely identifying a particular channel partner 106. Image 1508 can be uploaded by advertisers 102 while coupon is under design. Alternatively, advertisers 102 can select an image already saved on the system. As described above, any header text, secondary text and main text can be entered in the system and populate header text section 1510, second text section 1512 and main text section 1514.

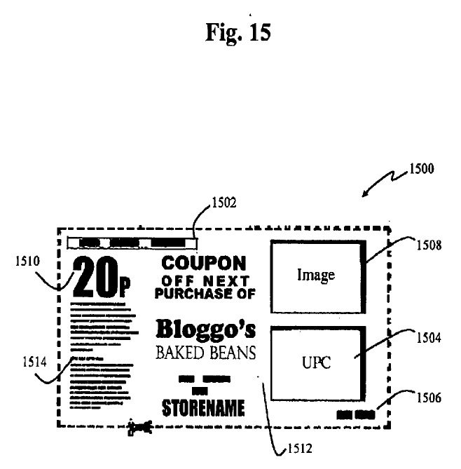

FIG. 16 illustrates an exemplary process for pooling and providing any of purchasing incentives and advertisements, such as coupons, from a global pool on the exemplary system. In at least one other exemplary embodiment, more than one global pool can be available and each global pool can be organized by a predetermined market, region, class of products, groups of channel partners 108 and the like. At step 1602, advertiser 102 is registered through first channel partner 108 or an affiliate. As described above, advertisers 102 can be registered at registration subportion 302 of advertisers module 232 of an exemplary website, which may be hosted by system provider 106 on behalf of first channel partner 108. Alternatively, as described above, advertisers 102 can be registered by affiliates at, for example, administrative subportion 1338 of affiliates module 234.

At step 1604, during or upon completion of registration at step 1602, advertiser 104 can be associated with first channel partner 108 or the affiliate. As described above, each channel partner 108 can be assigned a unique channel identifier. In addition, each affiliate can be assigned a unique affiliate identifier. At step 1604, the account of advertiser 104, which itself may have or contain a unique advertiser identifier, can be associated with the channel identifier or affiliate identifier.

At step 1606, registered advertiser 102 (or the affiliate acting on behalf thereof) can build one or more purchasing incentives or advertisements via the exemplary system. Any of purchasing incentives and advertisements, such as coupons, can be designed at, for example, promotional campaign subportion 332 of advertisers module 232 or promotional campaign subportion 1328 of affiliates module 234, as described above. Each purchasing incentive or advertisement can be assigned a unique identifier, which can be unique to the promotional campaign. In at least one exemplary embodiment, the unique identifier can be a unique number, which may be encoded in a barcode or other machine readable medium of a coupon (e.g., unique identifier 1506).

At step 1608, the purchasing incentive or advertisement can be associated with first channel partner 108 or the affiliate during or upon design at step 1606. The purchasing incentive or advertisement, and the first channel partner 108 or affiliate can be associated using respective unique identifiers. The unique identifiers can be used by the exemplary system (and users thereof) to track the purchasing incentive or advertisement by any of the promotional campaign, advertiser 104, first channel partner 108 and the affiliate. For instance, a channel identifier can be used by the exemplary system to track any of purchasing incentives and advertisements designed by advertisers 104 associated with a first channel partner 108 when the purchasing incentives or advertisements are provided on behalf of one or more second channel partners 108 to consumers 104 by system provider 106.

At step 1610, the purchasing incentive or advertisement can be grouped into the global pool of purchasing incentives/advertisements (e.g., if authorization has been provided by first channel partner 108 or affiliate). The global pool can be composed of any of purchasing incentives and advertisements, such as coupons, authorized to be pooled by a plurality of channel partners 108 or affiliates on one or more exemplary systems. In at least one exemplary embodiment, channel partners 108 having websites hosted by system provider 106 can be provided the option to permit pooling and shared access to any of purchasing incentives and advertisements designed by advertisers 102 (or affiliates acting on behalf thereof) and provided to consumers 104.

In at least one exemplary embodiment, first channel partner 108 can have the option of whether to permit any of purchasing incentives and advertisements, such as coupons, of associated advertisers 102 to enter a global pool. For instance, first channel partner 108 may opt to permit any of purchasing incentives and advertisements to enter the global pool and, in return, can present any of purchasing incentives and advertisements composing the global pool to consumers 104 via the exemplary website hosted by system provider 106 on behalf of first channel partner 108. By opting into the global pool, consumers 104 of first channel partner 108 can be provided access to any of purchasing incentives and advertisements, such as coupons, from advertisers 102 that are unassociated with first channel partner 108. First channel partner 108 can still maintain the ability to affirmatively select or veto which purchasing incentives or advertisements are provided on behalf of first channel partner 108. Such control can provide first channel partner 108 the flexibility to manage its brand and the needs of its consumers 104.

At step 1612, consumers 104 can be provided the purchasing incentive or advertisement via one or more websites hosted on behalf of one or more second channel providers 108. Second channel partners 108 can likewise authorize or not opt out from the purchasing incentive or advertisement being provided to their consumers 104 via their hosted websites. In at least one exemplary embodiment, the purchasing incentive or advertisement can be a coupon. Furthermore, advertisers 104 can be charged a fee based on coupons printed (or, alternatively, viewed) and revenue can be generated therefrom. The channel identifier for channel partner 108 can be used by the exemplary system to track the coupon when the coupon is provided to consumers 104 on websites hosted on behalf of second channel partners 108 by system provider 106.

At step 1614, the generated revenue can be shared with the first channel partner 108 or the affiliate of which advertiser 104 and the purchasing incentive or advertisement designed thereby is associated with. Revenue sharing between system provider 106 and first channel partners 108 or the affiliate can be based on a fixed or percentage amount (e.g., 50 percent) per coupons printed (or viewed), as a non-limiting example. In at least one exemplary embodiment, revenue can be shared differently based on whether a channel partner commission or an affiliate commission is to be paid. In addition, an affiliate commission may be paid to first channel provider 108 or vice versa as selected by system provider 106.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for providing purchasing incentives or advertisements, comprising:
one or more servers on a network;
one or more data storage devices on the network, the one or more data storage devices operatively connected to the one or more servers; and
an application suite stored and executable on the one or more servers, the application suite having more than one module, the more than one module comprising:
a first module for advertisers, the first module including purchasing incentive/advertisement design functionality, demographical-targeting functionality, promotional campaign planning functionality and promotional campaign management functionality; and
a second module for consumers, the second module providing any of a plurality of purchasing incentives and a plurality of advertisements via the network in at least one of a demographically-targeted manner, a searchable manner and a hierarchally-arranged manner, the second module including registration functionality wherein contact data and demographic data is solicited from consumers during a registration process.

2. The system of claim 1 wherein the application suite is hosted by a system provider on behalf of a channel partner and the more than one module further comprises:
a third module for the channel partner, the third module including administrative functionality.

3. The system of claim 1 wherein the more than one module further comprises:
a fourth module for a system provider, the fourth module including administrative functionality.

4. The system of claim 1 wherein the more than one module further comprises:
a fifth module for affiliates, the fifth module including purchasing incentive/advertisement design functionality, demographic-targeting functionality, promotional campaign planning functionality and promotional campaign management functionality.

5. The system of claim 1 wherein each of the more than one module is accessible by a web browser operating on a client computing device on the network.

6. The system of claim 1 wherein the plurality of purchasing incentives includes a plurality of printable coupons and the purchasing incentive/advertisement design functionality includes coupon design functionality.

7. The system of claim 1 wherein at least a portion of the network is the Internet.

8. The system of claim 1 wherein the first module further includes bulk email functionality.

9. The system of claim 1 wherein the purchasing incentive or advertisement design functionality provides preformatted templates populatable by data entry and provides image upload functionality.

10. The system of claim 1 wherein the first module provides the contact data of consumers for advertisers, wherein the contact data is accessible upon a printing of at least one purchasing incentive by each consumer.

11. A method of providing coupons to consumers, comprising:
providing a plurality of preformatted coupon templates and a plurality of template data entry mechanisms on an advertisers module of a website;
accepting a template selection and coupon data, the coupon data entered via the plurality of template data entry mechanisms;
populating a preformatted coupon template according to the template selection and the coupon data entered;
receiving a request to issue coupons on the advertisers module of the website; and
publishing a plurality of printable coupons on a consumers module of the website.

12. The method of claim 11, further comprising:
providing a plurality of demographic data entry mechanisms on the advertisers module of the website;
accepting demographic data entered via the plurality of demographic data entry mechanisms; and
associating the plurality of printable coupons with the demographic data.

13. The method of claim 11, further comprising:
providing a plurality of campaign planning data entry mechanisms on the advertisers module of the website;
accepting calendar period data entered via the plurality of campaign data entry mechanisms; and
limiting the publishing of coupons to a calendar period defined by the calendar period data.

14. The method of claim 11, further comprising:
receiving a request to print a coupon at the consumers module of the website;
determining if the request is from a registered and logged-in consumer;
if not, denying the request; and
prompting the consumer to register and login at the consumers module of the website;
if so, accepting the request; and
providing the coupon in printable form at the consumers module of the website.

15. The method of claim 14, further comprising;
charging a fee to an advertiser for providing the coupon in printable form.

16. The method of claim 15, further comprising:
collecting the fee from the advertiser; and
dividing the fee with a channel partner.

17. The method of claim 11, further comprising:
providing campaign data on at least one promotional campaign at the advertisers module of the website, wherein an indicium of the at least one promotional campaign is selectable and the campaign data includes data on a number of coupons printed for each promotional campaign;
receiving a selection of a promotional campaign; and
providing a plurality of data entry mechanisms for editing and updating the promotional campaign.

18. A method of sharing consumer data with advertisers, comprising:
publishing a plurality of coupons on a consumers module of a website, the plurality of coupons provided by advertisers;
limiting the printing of the plurality of coupons to registered consumers;
collecting consumer data from consumers during registration;
receiving requests to print the plurality of coupons;
accepting the requests to print the plurality of coupons;
providing the plurality of coupons in printable form; and
sharing the consumer data on an advertisers module of the website.

19. The method of claim 18, wherein consumer data is accessible to each advertiser once consumers have been provided a coupon of the advertiser in printable form.

20. The method of claim 18, wherein consumer data includes at least one of contact data, demographic data and categorical data.
